(19) United States
(12) Patent Application Publication
(10) Pub. No.: US 2025/0150119 A1
(43) Pub. Date: May 8, 2025

(54) METHOD AND APPARATUS FOR OPERATING BEAM IN WIRELESS COMMUNICATION SYSTEM

(71) Applicant: Samsung Electronics Co., Ltd., Suwon-si, Gyeonggi-do (KR)

(72) Inventors: Seunghyun LEE, Suwon-si (KR); Juho LEE, Suwon-si (KR); Jungsoo JUNG, Suwon-si (KR); Hanjin KIM, Suwon-si (KR); Byounghoon JUNG, Suwon-si (KR)

(21) Appl. No.: 18/696,123

(22) PCT Filed: Sep. 29, 2022
(86) PCT No.: PCT/KR2022/014697

§ 371 Date: Mar. 27, 2024

(30) Foreign Application Priority Data
Sep. 29, 2021 (KR) 10-2021-0129122

(51) Int. Cl. H04B 7/04

(52) U.S. Cl. CPC H04B 7/04026

(57) ABSTRACT

Disclosed is a method of a base station that supports beamforming in a wireless communication system, the method comprising the steps of: transmitting, to an RC, control information for controlling a plurality of reflective patterns of an RIS; transmitting synchronizing signals corresponding to a plurality of beams of the base station via the RIS to a terminal positioned in a shadow region, wherein the synchronizing signals are sent for each of the plurality of reflective patterns controlled on the basis of the control information; receiving, from the terminal, measurement reports containing measurement results of the intensities of the synchronizing signals corresponding to the plurality of beams of the base station, wherein the measurement reports are received for each of the plurality of reflective patterns; selecting at least one of the plurality of beams and at least one of the plurality of reflective patterns as an optimal beam and an optimal reflective pattern for the shadow region on the basis of the measurement results contained in the measurement reports; and generating a code book for the RIS on the basis of the selected optimal reflective pattern for the shadow region.

### CROSS-REFERENCE TO RELATED APPLICATION(S)

This application is a U.S. National Stage application under 35 U.S.C. § 371 of an International application number PCT/KR2022/014697, filed on Sep. 29, 2022, which is based on and claims the benefit of a Korean application number 10-2021-0129122, filed on Sep. 29, 2021, in the Korean Intellectual Property Office, the disclosure of which is incorporated by reference herein in its entirety.

### TECHNICAL FIELD

The disclosure relates to a method and apparatus for managing a beam of a base station in a wireless communication system.

### BACKGROUND ART

Wireless communication technologies have been developed mainly for human services, such as voice, multimedia, and data communication. As 5th-generation (5G) communication systems are commercially available, connected devices are expected to explosively increase and to be connected to a communication network. Examples of things connected to a network may include vehicles, robots, drones, home appliances, displays, smart sensors installed in various infrastructures, construction machinery, and factory equipment. Mobile devices will evolve into various form factors, such as augmented reality glasses, virtual reality headsets, and hologram devices. In the 6th-generation (6G) era, efforts are being made to develop an enhanced 6G communication system to provide various services by connecting hundreds of billions of devices and things. For this reason, the 6G communication system is called a beyond 5G system.

In the 6G communication system expected to be realized around year 2030, the maximum transmission rate is tera (i.e., 1000 gigabit) bps, and the wireless latency is 100 microseconds (usec). In other words, the transmission rate of the 6G communication system is 50 times faster than that of the 5G communication system, and the wireless latency is reduced to one tenth.

To achieve these high data rates and ultra-low latency, 6G communication systems are considered to be implemented in terahertz bands (e.g., 95 gigahertz (95 GHz) to 3 terahertz (3 THz) bands). As the path loss and atmospheric absorption issues worsen in the terahertz band as compared with millimeter wave (mmWave) introduced in 5G, technology that may guarantee signal reach, that is, coverage, would become more important. As major techniques for ensuring coverage, there need to be developed multi-antenna transmission techniques, such as new waveform, beamforming, massive multiple-input and multiple-output (MIMO), full dimensional MIMO (FD-MIMO), array antennas, or large-scale antennas, which exhibit better coverage characteristics than radio frequency (RF) devices and orthogonal frequency division multiplexing (OFDM). New technologies, such as a metamaterial-based lens and antennas, high-dimensional spatial multiplexing technology using an orbital angular momentum (OAM), and a reconfigurable intelligent surface (RIS), are being discussed to enhance the coverage of the terahertz band signals.

For 6G communication systems to enhance frequency efficiency and system network for 6G communication systems include full-duplex technology, there are being developed full-duplex technology in which uplink and downlink simultaneously utilize the same frequency resource at the same time, network technology that comprehensively use satellite and high-altitude platform stations (HAPSs), network architecture innovation technology that enables optimization and automation of network operation and supports mobile base stations, dynamic spectrum sharing technology through collision avoidance based on prediction of spectrum usages, artificial intelligence (AI)-based communication technology that uses AI from the stage of designing and internalizes end-to-end AI supporting function to thereby optimize the system, and next-generation distributed computing technology that realizes services that exceed the limitation of the UE computation capability by ultra-high performance communication and mobile edge computing (MEC) or clouds. Further, continuous attempts have been made to reinforce connectivity between device, further optimizing the network, prompting implementation of network entities in software, and increase the openness of wireless communication by the design of a new protocol to be used in 6G communication systems, implementation of a hardware-based security environment, development of a mechanism for safely using data, and development of technology for maintaining privacy.

Such research and development efforts for 6G communication systems would implement the next hyper-connected experience via hyper-connectivity of 6G communication systems which encompass human-thing connections as well as thing-to-thing connections. Specifically, the 6G communication system would be able to provide services, such as truly immersive extended reality (XR), high-fidelity mobile hologram, and digital replica. Further, services, such as remote surgery, industrial automation and emergency response would be provided through the 6G communication system thanks to enhanced security and reliability and would have various applications in medical, auto, or home appliance industries.

Recently, there is a limitation in resolving a shadow area in a cell with a single base station in a high frequency environment such as an mmWave band, etc., and research on a reconfigurable intelligent surface (RIS) has been conducted as a solution for this. In this case, the term Intelligent reflecting surface (IRS) may be used instead of the term RIS.

The RIS may form a reflection pattern by combining the phases and/or amplitudes of respective reflecting elements (REs) included in the RIS and reflect a beam incident on the RIS in a desired direction according to the reflection pattern.

There is a need for a method of selecting an appropriate beam and reflection pattern from among a plurality of beams and a plurality of reflection patterns to eliminate a shadow area in an environment where a base station supports a plurality of beams and an RIS supports a plurality of reflection patterns.

### DETAILED DESCRIPTION OF THE INVENTION

### Technical Problem

An aspect of the disclosure is to provide a method and apparatus for managing a beam in a wireless communication system.

An aspect of the disclosure is to provide a method and apparatus for efficiently transmitting and receiving signals to and from a terminal in a shadow area through beamforming by a base station in a wireless communication system.

An aspect of the disclosure is to provide a method and apparatus for efficiently performing communication between a base station and a terminal using an RIS in a wireless communication system.

### Technical Solution

The disclosure provides a method of a base station supporting beamforming in a wireless communication system, and the method may comprise transmitting control information for controlling a plurality of reflection patterns of an RIS to an RIS controller (RC), transmitting synchronization signals corresponding to a plurality of beams of the base station for each of the plurality of reflection patterns controlled based on the control information to a terminal located at a shadow area via the RIS; receiving a measurement report including a measurement result of measuring strength of the synchronization signals corresponding to the plurality of beams of the base station for each of the plurality of reflection patterns from the terminal; selecting at least one beam among the plurality of beams and at least one reflection pattern among the plurality of reflection patterns as an optimal beam and an optimal reflection pattern for the shadow area, based on the measurement result included in the measurement report; and generating a codebook for the RIS based on the selected optimal reflection pattern for the shadow area.

In an embodiment, the control information may be transmitted only once for the plurality of reflection patterns.

In an embodiment, the control information may include at least one of timing information indicating a time point at which the terminal measures the strength of the synchronization signals corresponding to the plurality of beams of the base station for each of the plurality of reflection patterns, indication information indicating each of the plurality of reflection patterns and order information indicating an order in which the plurality of reflection patterns are controlled, information about a transmission period of the synchronization signals corresponding to the plurality of beams, and information indicating a number of times the transmission period of the synchronization signals is repeated for each of the plurality of reflection patterns.

In an embodiment, the control information may include at least one of timing information indicating a time point at which the terminal measures the strength of the synchronization signals corresponding to the plurality of beams of the base station for each of the plurality of reflection patterns, indication information indicating each of the plurality of reflection patterns and information indicating an order in which the plurality of reflection patterns are controlled, and information indicating time at which each of the plurality of reflection patterns is controlled.

In an embodiment, the control information may be transmitted for each of the plurality of reflection patterns.

In an embodiment, the control information may include at least one of timing information indicating a time point at which the terminal measures the strength of the synchronization signals corresponding to the plurality of beams of the base station for a reflection pattern corresponding to the control information, indication information indicating the reflection pattern corresponding to the control information among the plurality of reflection patterns, information about a transmission period of the synchronization signals corresponding to the plurality of beams, and information indicating a number of times the transmission period of the synchronization signals is repeated for the reflection pattern corresponding to the control information.

In an embodiment, the control information may include at least one of timing information indicating a time point at which the terminal measures the strength of the synchronization signals corresponding to the plurality of beams of the base station for a reflection pattern corresponding to the control information, indication information indicating the reflection pattern corresponding to the control information among the plurality of reflection patterns, and information indicating a time at which the reflection pattern corresponding to the control information is controlled.

In an embodiment, the measurement result may include, for each of the plurality of reflection patterns, information about at least one reflection pattern and at least one beam, which correspond to a case that strength of a signal among the synchronization signals corresponding to the plurality of beams satisfies a predetermined threshold value or more.

The disclosure provides a base station supporting beamforming in a wireless communication system, and the base station may comprise a transceiver, and a controller configured to, control the transceiver to transmit control information for controlling a plurality of reflection patterns of an RIS to an RC, control the transceiver to transmit synchronization signals corresponding to a plurality of beams of the base station for each of the plurality of reflection patterns controlled based on the control information to a terminal via the RIS, control the transceiver to receive a measurement report including a measurement result of measuring strength of the synchronization signals corresponding to the plurality of beams of the base station for each of the plurality of reflection patterns from the terminal, select at least one beam among the plurality of beams and at least one reflection pattern among the plurality of reflection patterns as an optimal beam and an optimal reflection pattern for a shadow area, based on the measurement result included in the measurement report, and generate a codebook for the RIS based on the selected optimal reflection pattern for the shadow area.

In an embodiment, the control information may be transmitted only once for the plurality of reflection patterns.

In an embodiment, the control information may include at least one of timing information indicating a time point at which the terminal measures the strength of the synchronization signals corresponding to the plurality of beams of the base station for each of the plurality of reflection patterns, indication information indicating each of the plurality of reflection patterns and order information indicating an order in which the plurality of reflection patterns are controlled, information about a transmission period of the synchronization signals corresponding to the plurality of beams, and information indicating a number of times the transmission period of the synchronization signals is repeated for each of the plurality of reflection patterns.

In an embodiment, the control information may include at least one of timing information indicating a time point at which the terminal measures the strength of the synchronization signals corresponding to the plurality of beams of the base station for each of the plurality of reflection patterns, indication information indicating each of the plurality of reflection patterns and information indicating an order in which the plurality of reflection patterns are controlled, and information indicating time at which each of the plurality of reflection patterns is controlled.

In an embodiment, the control information may be transmitted for each of the plurality of reflection patterns.

In an embodiment, the control information may include at least one of timing information indicating a time point at which the terminal measures the strength of the synchronization signals corresponding to the plurality of beams of the base station for a reflection pattern corresponding to the control information, indication information indicating the reflection pattern corresponding to the control information among the plurality of reflection patterns, information about a transmission period of the synchronization signals corresponding to the plurality of beams, and information indicating a number of times the transmission period of the synchronization signals is repeated for the reflection pattern corresponding to the control information

In an embodiment, the control information may include at least one of timing information indicating a time point at which the terminal measures the strength of the synchronization signals corresponding to the plurality of beams of the base station for a reflection pattern corresponding to the control information, indication information indicating the reflection pattern corresponding to the control information among the plurality of reflection patterns, and information indicating a time at which the reflection pattern corresponding to the control information is controlled.

In an embodiment, the measurement result may include, for each of the plurality of reflection patterns, information about at least one reflection pattern and at least one beam, which correspond to a case that strength of a signal among the synchronization signals corresponding to the plurality of beams satisfies a predetermined threshold value or more.

The disclosure provides a method of a base station supporting beamforming in a wireless communication system, and the method may comprise transmitting control information for controlling at least one reflection pattern among a plurality of reflection patterns of an RIS during a predetermined time interval to an RC; transmitting synchronization signals corresponding to a plurality of beams of the base station for the at least one reflection pattern controlled based on the control information during the predetermined time interval to a terminal located at a shadow area via the RIS; identifying whether the terminal establishes a connection with the base station according to a random access procedure during the predetermined time interval; if the terminal establishes the connection with the base station according to the random access procedure during the predetermined time interval, identifying log information associated with the random access procedure of the terminal; identifying at least one synchronization signal for which the random access procedure is successfully performed among the plurality of synchronization signals from the log information; selecting the at least one reflection pattern and a beam corresponding to the at least one synchronization signal among the plurality of beams as an optimal reflection pattern and an optimal beam for the shadow area, respectively; and generating a codebook for the RIS based on the selected optimal reflection pattern for the shadow area.

The disclosure provides a base station supporting beamforming in a wireless communication system, and the base station may comprise a transceiver, and a controller configured to, control the transceiver to transmit control information for controlling at least one reflection pattern among a plurality of reflection patterns of an RIS during a predetermined time interval to an RC, control the transceiver to transmit synchronization signals corresponding to a plurality of beams of the base station for the at least one reflection pattern controlled based on the control information during the predetermined time interval to a terminal located at a shadow area via the RIS, identify whether the terminal establishes a connection with the base station according to a random access procedure during the predetermined time interval, if the terminal establishes the connection with the base station according to the random access procedure during the predetermined time interval, identify log information associated with the random access procedure of the terminal, identify at least one synchronization signal for which the random access procedure is successfully performed among the plurality of synchronization signals from the log information, select the at least one reflection pattern and a beam corresponding to the at least one synchronization signal among the plurality of beams as an optimal reflection pattern and an optimal beam for the shadow area, respectively, and generate a codebook for the RIS based on the selected optimal reflection pattern for the shadow area.

The disclosure provides a method of a base station supporting beamforming in a wireless communication system, and the method may comprise obtaining location information for at least one terminal based on location information of a shadow area, obtaining identifier information for the at least one terminal based on the location information for the at least one terminal, identifying whether a connection between the at least one terminal and the base station is released, if the connection between the at least one terminal and the base station is released, transmitting control information for controlling at least one reflection pattern among a plurality of reflection patterns of an RIS during a predetermined time interval to an RC; transmitting synchronization signals corresponding to a plurality of beams of the base station for the at least one reflection pattern controlled based on the control information during the predetermined time interval to the at least one terminal via the RIS; identifying whether the at least one terminal re-establishes a connection with the base station according to a random access procedure during the predetermined time interval based on the identifier information for the at least one terminal; if the at least one terminal re-establishes the connection with the base station according to the random access procedure during the predetermined time interval based on the identifier information for the at least one terminal, identifying log information associated with the random access procedure of the at least one terminal; identifying at least one synchronization signal for which the random access procedure is successfully performed among the plurality of synchronization signals from the log information; selecting the at least one reflection pattern and a beam corresponding to the at least one synchronization signal among the plurality of beams as an optimal reflection pattern and an optimal beam for the shadow area, respectively; and generating a codebook for the RIS based on the selected optimal reflection pattern for the shadow area.

The disclosure provides a base station supporting beamforming in a wireless communication system, and the base station may comprise a transceiver, and a controller configured to, obtain location information for at least one terminal based on location information of a shadow area, obtain identifier information for the at least one terminal based on the location information for the at least one terminal, identify whether a connection between the at least one terminal and the base station is released, control the transceiver to transmit control information for controlling at least one reflection pattern among a plurality of reflection patterns of an RIS during a predetermined time interval to an RC if the connection between the at least one terminal and the base station is released, control the transceiver to transmit synchronization signals corresponding to a plurality of beams of the base station for the at least one reflection pattern controlled based on the control information during the predetermined time interval to the at least one terminal via the RIS, identify whether the at least one terminal re-establishes a connection with the base station according to a random access procedure during the predetermined time interval based on the identifier information for the at least one terminal, identify log information associated with the random access procedure of the at least one terminal if the at least one terminal re-establishes the connection with the base station according to the random access procedure during the predetermined time interval based on the identifier information for the at least one terminal, identify at least one synchronization signal for which the random access procedure is successfully performed among the plurality of synchronization signals from the log information, select the at least one reflection pattern and a beam corresponding to the at least one synchronization signal among the plurality of beams as an optimal reflection pattern and an optimal beam for the shadow area, respectively, and generate a codebook for the RIS based on the selected optimal reflection pattern for the shadow area.

### Advantageous Effects

According to various embodiments of the disclosure, a base station may efficiently communicate with terminals using an RIS.

According to various embodiments of the disclosure, a base station may efficiently communicate with a terminal located at a shadow area via an optimal beam and an optimal reflection pattern.

The effects of the disclosure are not limited to those mentioned above, and other effects not mentioned will be apparent to those skilled in the art from the following description.

### BRIEF DESCRIPTION OF DRAWINGS

FIG. 1 is a diagram illustrating a time-frequency domain structure in LTE according to various embodiments of the disclosure.

FIG. 2 is a diagram illustrating a downlink control channel in LTE according to various embodiments of the disclosure.

FIG. 3 is a diagram illustrating a transmission resource of a downlink control channel in 5G according to various embodiments of the disclosure.

FIG. 4 is a diagram illustrating an example of configuration for a control region in 5G according to various embodiments of the disclosure.

FIG. 5 is a diagram illustrating an example of configuration for a downlink RB structure in 5G according to various embodiments of the disclosure.

FIG. 6 is a diagram schematically illustrating a structure of a wireless communication system including an RIS according to various embodiments of the disclosure.

FIGS. 7A, 7B, and 7C are diagrams for explaining an operating principle of an RIS according to various embodiments of the disclosure.

FIG. 8 is a diagram for explaining an optimal beam of a base station and an optimal reflection pattern of an RIS for a target shadow area, according to various embodiments of the disclosure.

FIGS. 9A and 9B are diagrams for explaining a method of obtaining an optimal beam of a base station and an optimal reflection pattern of an RIS using a measurement result for a base station-synchronization signal in a test terminal according to the first embodiment of the disclosure.

FIGS. 10A and 10B are diagrams for explaining a method of transmitting a control signal to an RC by a base station in FIG. 9 according to the first embodiment of the disclosure.

FIG. 11 is a diagram for explaining timing information at which measurement needs to be started to obtain an optimal beam of a base station and an optimal reflection pattern of an RIS in a case that the base station and an RC are connected through in-band according to the first embodiment of the disclosure.

FIG. 12 is a diagram for explaining information about timing at which measurement is started to obtain an optimal beam of a base station and an optimal reflection pattern of an RIS in a case that the base station and an RC are connected through out-band according to the first embodiment of the disclosure.

FIG. 13 is a diagram for explaining timing information at which measurement needs to be started to obtain an optimal beam of a base station and an optimal reflection pattern of an RIS in a case that the base station and an RC are connected via other communication scheme according to the first embodiment of the disclosure.

FIGS. 14A and 14B are diagrams for explaining a method for a test terminal to obtain an optimal beam of a base station and an optimal reflection pattern of an RIS by performing a random access procedure with the base station according to the second embodiment of the disclosure.

FIG. 15 is a diagram for explaining a method for a base station to specify a test terminal according to the second embodiment of the disclosure.

FIG. 16 is a diagram for explaining a method for a general terminal to obtain an optimal beam of a base station and an optimal reflection pattern of an RIS by performing a random access procedure with the base station according to the third embodiment of the disclosure.

FIG. 17 is a diagram schematically illustrating an internal structure of a terminal according to an embodiment of the disclosure.

FIG. 18 is a diagram schematically illustrating an internal structure of a base station according to an embodiment of the disclosure.

FIG. 19 is a diagram schematically illustrating an internal structure of an RC according to an embodiment of the disclosure.

### MODE FOR CARRYING OUT THE INVENTION

Preferred embodiments of the disclosure will be described below in detail with reference to the accompanying drawings. It is to be noted that like reference numerals denote the same components in the drawings. Lest it should obscure the subject matter of the disclosure, a detailed description of a generally known function or structure of will be avoided.

In describing embodiments, a description of technical content which is well known in the technical field of the disclosure and not directly related to the disclosure will be avoided, lest it should obscure the subject matter of the disclosure. This is done to make the subject matter of the disclosure clearer without obscuring it by omitting an unnecessary description.

For the same reason, some components are shown as exaggerated, omitted, or schematic in the accompanying drawings. In addition, the size of each component does not fully reflect the actual size. In each drawing, the same reference numerals are assigned to the same or corresponding components.

The advantages and features of the disclosure and a method of achieving them will become apparent from reference to embodiments described below in detail in conjunction with the attached drawings. However, the disclosure may be implemented in various manners, not limited to the embodiments set forth herein. Rather, these embodiments are provided such that the disclosure is complete and thorough and its scope is fully conveyed to those skilled in the art, and the disclosure is only defined by the appended claims. The same reference numerals denote the same components throughout the specification.

It will be understood that each block of the flowchart illustrations and combinations of the flowchart illustrations can be implemented by computer program instructions. These computer program instructions may be loaded on a processor of a general purpose computer, special purpose computer, or other programmable data processing equipment, such that the instructions, which are executed through the processor of the computer or other programmable data processing equipment, create means for implementing the functions specified in the flowchart block(s). These computer program instructions may also be stored in a computer-usable or computer-readable memory that can direct the computer or other programmable data processing equipment to function in a particular manner, such that the instructions stored in the computer-usable or computer-readable memory produce an article of manufacture including instruction means which implement the function specified in the flowchart block(s). The computer program instructions may also be loaded onto the computer or other programmable data processing equipment to cause a series of operations to be performed on the computer or other programmable data processing equipment to produce a computer implemented process such that the instructions which are executed on the computer or other programmable equipment provide operations for implementing the functions specified in the flowchart block(s).

Furthermore, the respective block diagrams may illustrate parts of modules, segments, or codes including one or more executable instructions for performing specific logic function(s). Moreover, it should be noted that the functions of the blocks may be performed in a different order in several alternative implementations. For example, two successive blocks may be performed substantially at the same time, or may be performed in reverse order according to their functions.

The term ‘unit’ as used herein means, but is not limited to, a software or hardware component, such as a field programmable gate array (FPGA) or application specific integrated circuit (ASIC), which performs certain tasks. A ‘unit’ may be configured to reside on an addressable storage medium and configured to be executed on one or more processors. Thus, a ‘unit’ may include, by way of example, components, such as software components, object-oriented software components, class components and task components, processes, functions, attributes, procedures, subroutines, segments of program code, drivers, firmware, microcode, circuitry, data, databases, data structures, tables, arrays, and variables. The functionality provided in the components and ‘units’ may be combined into fewer components and ‘units’ or further separated into additional components and ‘units’. In addition, the components and ‘units’ may be implemented such that they are executed on one or more CPUs in a device or a secure multimedia card.

In embodiments of the disclosure, a base station, which is an entity to allocate resources to a terminal, may be at least one of a gNode B, a gNB, an eNode B, an eNB, a Node B, a BS, a radio access unit, a base station controller, or a network node. Further, the base station may be a network entity including at least one of an integrated access and backhaul (IAB)-donor that is a gNB providing network access to terminal(s) through a network of backhaul and access links or an IAB-node that is a radio access network (RAN) node supporting NR access link(s) to terminal(s) and supporting NR backhaul links to the IAB-donor or another IAB-node in an NR system. A terminal may be wirelessly coupled to an IAB-donor through an IAB-node and transmit and receive data to and from the IAB-donor coupled to at least one IAB-node through a backhaul link.

Further, the terminal may include a user equipment (UE), a mobile station (MS), a cellular phone, a smart phone, a computer, or various devices capable of executing a communication function. In the disclosure, downlink (DL) is a wireless transmission path of a signal transmitted from a base station to a terminal, and uplink (UL) is a wireless transmission path of a signal transmitted from a terminal to a base station. While an LTE or LTE-A system may be described below as an example, embodiments of the disclosure are applicable to other communication systems having a similar technical background or channel structure. For example, the communication systems may include 5th generation (5G) new radio (5G NR) developed after LTE-A, and 5G may be a concept encompassing legacy LTE, LTE-A, and other similar services in the following description. Further, the disclosure is also applicable to other communication systems through some modifications without greatly departing from the scope of the disclosure as judged by those skilled in the art.

As used in the following description, terms referring to signals, terms referring to channels, terms referring to control information, terms referring to network entities, terms referring to components of a device, and the like are exemplified for ease of description. In addition, as used in the following description, terms used to identify nodes, terms referring to messages, terms referring to interfaces between network entities, terms referring to various pieces of information, and so on are exemplified for ease of description. Therefore, the disclosure is not limited to the terms described herein, and other terms having equivalent technical meanings may be used.

In addition, although the disclosure describes various embodiments using terminology used in some communication standards (e.g., 3rd Generation Partnership Project (3GPP)), this is for illustrative purposes only. Various embodiments of the disclosure may be readily adapted and applied to other communication systems.

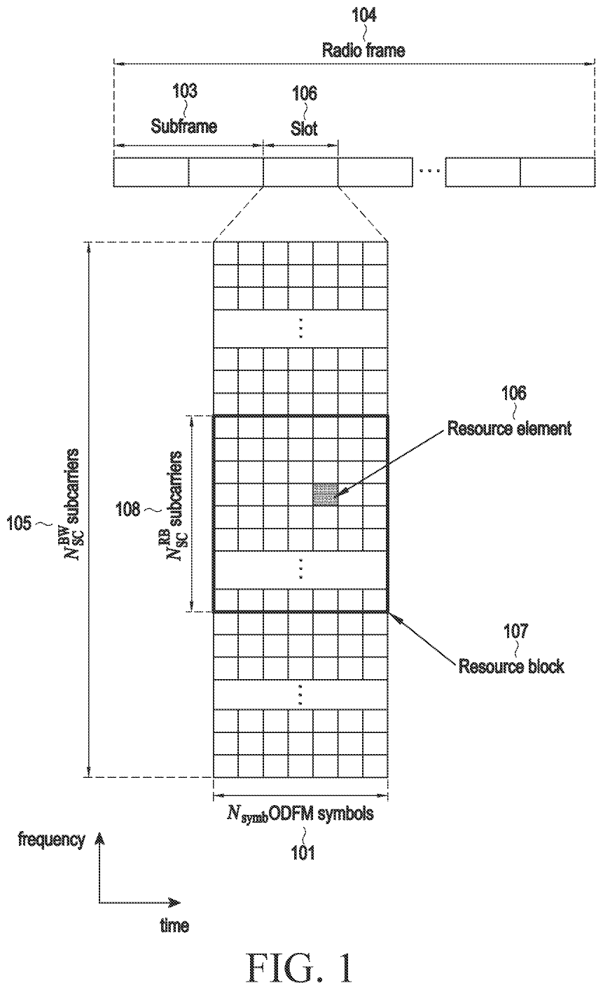

FIG. 1 is a diagram illustrating a time-frequency domain structure in an LTE system according to various embodiments of the disclosure.

Referring to FIG. 1, a horizontal axis represents a time domain, and a vertical axis represents a frequency domain.

A minimum transmission unit in the time domain is an OFDM symbol, N_{symb} OFDM symbols 101 form one slot 102, and two slots form one subframe 103. The length of a slot is 0.5 ms, and the length of a subframe is 1.0 ms. A radio frame 104 is a time-domain unit including 10 subframes. A minimum transmission unit in the frequency domain is a subcarrier, and a total system bandwidth includes N_{SC}^{BW} subcarriers 105. A basic resource unit in the time-frequency domain is a Resource Element (RE) 106, which may be represented by an OFDM symbol index and a subcarrier index. A Resource Block (RB) (or a Physical Resource Block (PRB)) 107 is defined as N_{symb} consecutive OFDM symbols 101 in the time domain by N_{SC}^{RB} consecutive subcarriers 108 in the frequency domain. Thus, one RB 108 includes N_{symb}×N_{SC}^{RB} REs 106. Generally, a minimum data transmission unit is in RBs. In the LTE system, typically N_{symb}=7 and N_{SC}^{RB}=12 where N_{SC}^{BW} 105 and N_{SC}^{RB} 108 are proportional to the bandwidth of a system transmission band.

Downlink control information (DCI) in LTE and LTE-Advanced (LTE-A) systems will be described below in detail.

In the LTE system, scheduling information for DL data or UL data is transmitted in DCI from a base station to a terminal. Several DCI formats are defined and operated by applying the defined DCI formats depending on whether scheduling information is for UL data or DL data, whether DCI is compact DCI with a small size of control information, whether spatial multiplexing using multiple antennas is applied, whether DCI is for power control, and so on. For example, DCI format 1, which is scheduling control information for DL data, is configured to include at least the following control information.
Resource allocation type 0/1 flag: Indicates whether the resource allocation scheme is type 0 or type 1. Type 0 applies a bitmap scheme to allocate resources on a resource block group (RBG) basis. In the LTE system, a basic scheduling unit is a resource block (RB) represented by time and frequency-domain resources, and an RBG includes a plurality of RBs, which is a basic scheduling unit in type 0. Type 1 allows for allocation of a specific RB in an RBG.
Resource block assignment: Indicates an RB assigned for data transmission. Represented resources are determined according to a system bandwidth and a resource allocation scheme.
Modulation and Coding Scheme (MCS): Indicates a modulation scheme used for data transmission and the size of a transport block, which is data to be transmitted.
HARQ process number: Indicates the number of an HARQ process.
New data indicator: Indicates an HARQ initial transmission or an HARQ retransmission.
Redundancy version: Indicates an HARQ redundancy version.
Transmit Power Control (TPC) command for Physical Uplink Control CHannel (PUCCH): Indicates a TPC command for a UL control channel, PUCCH.

The DCI is transmitted through a physical control channel, physical downlink control channel (PDCCH) after channel coding and modulation.

DCI message payload is attached with a Cyclic Redundancy Check (CRC), which is scrambled with a Radio Network Temporary Identifier (RNTI) corresponding to the identity of a terminal. Different RNTIs are used depending on the purposes of DCI messages, for example, terminal-specific (UE-specific) data transmission, a power control command, or a random access response. That is, the RNTI is not transmitted explicitly but is included in CRC calculation. When receiving a DCI message transmitted on a PDCCH, the terminal may identify a CRC using an assigned RNTI, and when a CRC check result is correct, know that the message is directed to the terminal.

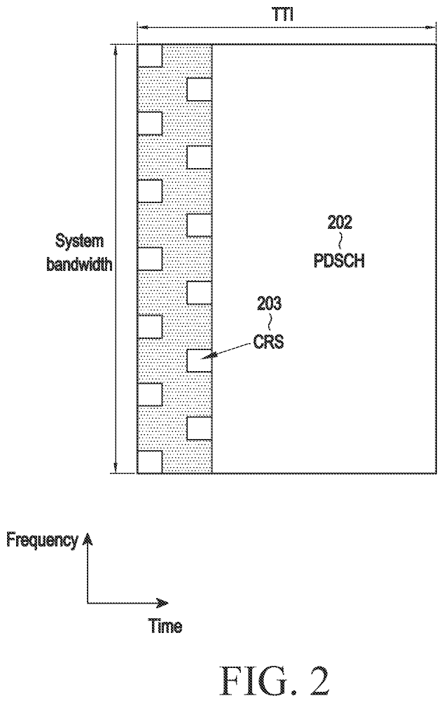

FIG. 2 is a diagram illustrating a DL control channel in LTE according to various embodiments of the disclosure. The DL control channel in LTE may be, for example, a PDCCH 201.

Referring to FIG. 2, the PDCCH 201 is time-multiplexed with a data transmission channel, Physical Downlink Shared CHannel (PDSCH) 202 and transmitted across a total system bandwidth. A region of the PDCCH 201 is represented as the number of OFDM symbols and indicated to a terminal by a Control Format Indicator (CFI) transmitted on a Physical Control Format Indicator CHannel (PCFICH). As the PDCCH 201 is assigned to starting OFDM symbols of a subframe, it has the advantage of allowing the terminal to decode a DL scheduling assignment as soon as possible, thereby reducing the decoding delay of a DownLink Shared CHannel (DL-SCH), that is, an overall DL transmission delay. Since one PDCCH carries one DCI message and multiple terminals may be scheduled simultaneously on DL and UL, multiple PDCCHs may be transmitted simultaneously within each cell. A cell-specific reference signal (CRS) 203 is used as a reference signal (RS) for decoding the PDCCH 201. The CRS 203 is transmitted across the total band in every subframe and subject to different scrambling and resource mapping depending on a cell identity (ID). Since the CRS 203 is an RS common to all terminals, terminal-specific beamforming may not be used. Therefore, a multi-antenna transmission scheme for the PDCCH in LTE is limited to open-loop transmit diversity. The number of ports for the CRS 203 is implicitly known to the terminal from decoding of a Physical Broadcast CHannel (PBCH).

Resource allocation for the PDCCH 201 is based on a Control-Channel Element (CCE), and one CCE includes 9 Resource Element Groups (REGs), that is, a total of 36 Resource Elements (REs). The number of CCEs required for a specific PDCCH 201 may be 1, 2, 4, or 8, depending on the channel coding rate of DCI message payload. These different numbers of CCEs are used to implement link adaptation of the PDCCH 201. Since the terminal has to detect the signal without knowing information about the PDCCH 201, a search space representing a set of CCEs for blind decoding is defined in LTE. The search space includes a plurality of sets for each aggregation level (AL) of CCEs, which is not explicitly signaled but is implicitly defined by a function of the terminal identity and a subframe number. In each subframe, the terminal decodes the PDCCH 201 for every possible resource candidate that may be produced from CCEs within a configured search space, and processes information declared valid for the terminal by a CRC check.

Search spaces are categorized into a terminal-specific search space and a common search space. A certain group of terminals or all terminals may monitor the search space of the PDCCH 201 to receive cell-common control information such as dynamic scheduling of system information or a paging message. For example, scheduling allocation information for a DL-SCH for transmission of System Information Block (SIB)-1 including cell operator information may be received by monitoring a common search space of the PDCCH 201.

In LTE, an entire PDCCH region includes a set of CCEs in a logical area, and there exists a search space including a set of CCEs. The search space is divided into a common search space and a terminal-specific search space, and the search space of the LTE PDCCH is defined as follows in the 3GPP communication standard specification TS 38.213.

```
The set of PDCCH candidates to monitor are defined in terms of search
spaces, where a search space Sₖ^{(L)} at aggregation level L ∈ {1,2,4,8} is
defined by a set of PDCCH candidates. For each serving cell on which
PDCCH is monitored, the CCEs corresponding to PDCCH candidate m of
the search space Sₖ^{(L)} are given by
          L {(Yₖ + m′)mod└N_{CCE,k} / L┘}+ i
where Yₖ is defined below, i = 0,..., L − 1 . For the common search space
m′ = m . For the PDCCH UE specific search space, for the serving cell on
which PDCCH is monitored, if the monitoring UE is configured with
carrier indicator field then m′ = m + M^{(L)}·n_{CI} where n_{CI} is the
carrier indicator field value, else if the monitoring UE is not configured
with carrier indicator field then m′ = m , where m = 0,...,M^{(L)} − 1.
M^{(L)} is the number of PDCCH candidates to monitor in the given search
space.
Note that the carrier indicator field value is the same as ServCellIndex
For the common search spaces, Yₖ is set to 0 for the two aggregation
levels L = 4 and L = 8 .
For the UE-specific search space Sₖ^{(L)} at aggregation level L , the variable
Yₖ is defined by
          Yₖ =(A·Y_{k 1})mod D
where Y₋₁ = n_{RNTI} ≠ 0 , A = 39827, D = 65537 and k = └nₛ/2┘ , nₛ
is the slot number within a radio frame.
The RNTI value used for n_{RNTI} is defined in subclause 7.1 in downlink
and subclause 8 in uplink.
```

According to the definition of the search space for the PDCCH described above, the terminal-specific search space is not explicitly signaled, but is implicitly defined as a function of a terminal identity and a subframe number. In other words, the terminal-specific search space may change depending on a subframe number, which means that it may change over time and thus solves the problem of blocking a specific terminal from using the search space by other terminals. When a terminal is not scheduled in a subframe because all CCEs monitored by the terminal are already occupied by other terminals scheduled in the same subframe, the terminal may not experience this problem in a next subframe because the search space changes over time. For example, even though a terminal #1 and a terminal #2 have a partial overlap in their terminal-specific search spaces in a given subframe, it may be expected that the overlap will change in a next subframe because the terminal-specific search spaces change on a subframe basis.

According to the definition of the search space for the PDCCH described above, the common search space is defined as a preset set of CCEs because a certain group of terminals or all terminals need to receive the PDCCH. In other words, the common search space does not change based on a terminal identity or a subframe number. Although the common search space exists for transmission of various system messages, it may also be used to transmit control information for an individual terminal. This may be used as a solution to the problem of a terminal not being scheduled due to insufficient resources available for a terminal-specific search space.

A search space is a set of candidate control channels including CCEs that a terminal needs to attempt to decode at a given AL. There are several ALs each creating a group of 1, 2, 4, or 8 CCEs, and thus the terminal has a plurality of search spaces. For the LTE PDCCH, the number of PDCCH candidates that the terminal needs to monitor within a search space, defined for each AL is defined in the following Table 1 according to the 3GPP communication standard specification TS 38.213.

TABLE 1

| Search space Sₖ^{(L)} | | | Number of PDCCH |
|---|---|---|---|
| Type | Aggregation level _{L} | Size [in CCEs] | candidates M^{(L)} |
| UE-specific | 1 | 6 | 6 |
| | 2 | 12 | 6 |
| | 4 | 8 | 2 |
| | 8 | 16 | 2 |
| Common | 4 | 16 | 4 |
| | 8 | 16 | 2 |

According to Table 1, the terminal-specific search space supports ALs {1, 2, 4, 8}, for which there are {6, 6, 2, 2} PDCCH candidates, respectively. A common search space 302 supports ALs {4, 8} having {4, 2} PDCCH candidates, respectively. The reason for supporting only the ALs {4, 8} by the common search space is to enhance coverage characteristics because a system message typically needs to reach a cell edge.

DCI transmitted in the common search space is only defined in a specific DCI format such as 0/1A/3/3A/1C corresponding to system messages or purposes such as power control for a group of terminals. A DCI format with spatial multiplexing is not supported in the common search space. A DL DCI format to be decoded in a terminal-specific search space depends on a transmission mode configured for a corresponding terminal. Since the transmission mode is configured by Radio Resource Control (RRC) signaling, there is no precise subframe number specified to indicate when the configuration for the terminal is effective. Therefore, the terminal may operate to always decode DCI format 1A regardless of the transmission mode so as not to lose communication.

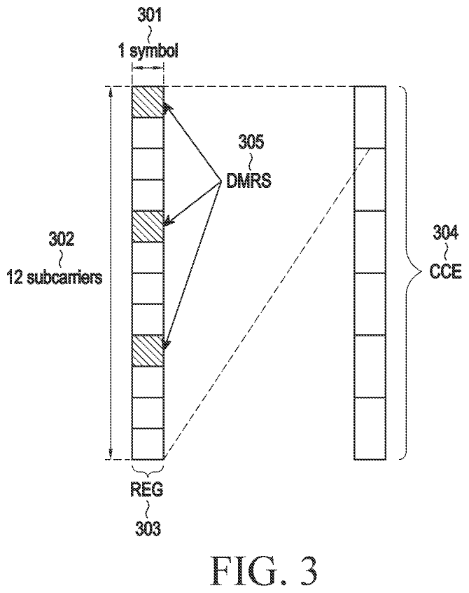

FIG. 3 is a diagram illustrating transmission resources of a DL control channel in 5G according to various embodiments of the disclosure. Specifically, FIG. 3 illustrates an exemplary basic unit of time and frequency resources included in a DL control channel available in 5G. Referring to FIG. 3, a basic unit (an REG) of time and frequency resources for a control channel includes one OFDM symbol 301 on the time axis and 12 subcarriers 302, that is, one RB on the frequency axis. The assumption of one OFDM symbol 301 as a basic time-axis unit in configuring a basic unit of a control channel may enable time-multiplexing between a data channel and a control channel in one subframe. As the control channel precedes the data channel, the resulting reduction of a processing time for the user facilitates meeting latency requirements. The configuration of a basic frequency-axis unit for the control channel as one RB 302 may enable more efficient frequency multiplexing between the control channel and the data channel.

Referring to FIG. 3, various sizes of control channel regions may be configured by concatenating REGs 303. For example, when a basic unit allocated to a DL control channel in 5G is a CCE 304, one CCE 304 may include multiple REGs 303. Referring to FIG. 3, for example, when 12 REs are available as an REG 303 and one CCE 304 includes 6 REGs 303, this implies that one CCE 304 may include 72 REs. When a DL control region is configured, it may include a plurality of CCEs 304, and a specific DL control channel may be mapped to and transmitted in one or more CCEs 304 according to an AL within the control region. The CCEs 304 in the control region may be distinguished by their numbers, which may be assigned according to a logical mapping scheme.

Referring to FIG. 3, an REG 303 may include both REs to which DCI is mapped and an area to which an RS for decoding the DCI, Demodulation Reference Signal (DMRS) 305 is mapped. For example, the DMRS 305 may be transmitted in six REs within one REG 303. Since the DMRS 303 is transmitted by the same precoding as a control signal mapped to the REG 303, the terminal may decode the control information without information about the precoding applied by a base station.

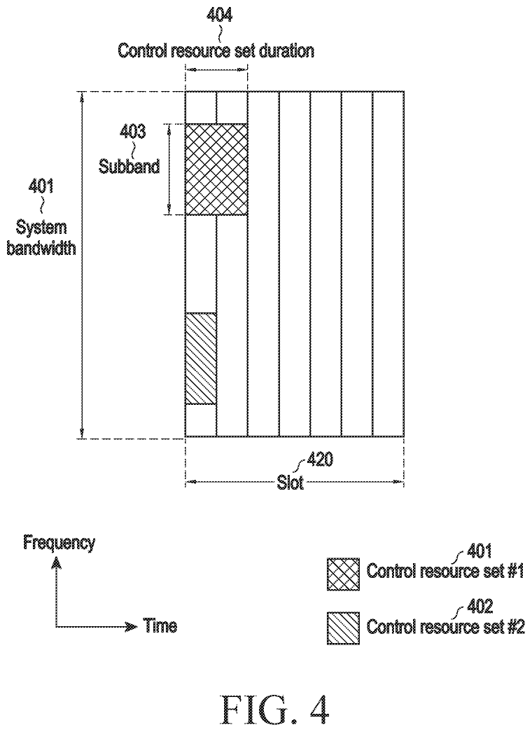

FIG. 4 is a diagram illustrating an exemplary configuration for a control region in a 5G wireless communication system according to various embodiments of the disclosure. Specifically, FIG. 4 illustrates an example of a Control Resource Set (CORESET) in which a DL control channel is transmitted. Referring to FIG. 4, two control regions (control region #1 401 and control region #2 402) may be configured in a system bandwidth 410 on the frequency axis and in one slot 420 on the time axis. Referring to FIG. 4, it is assumed that one slot includes 7 OFDM symbols. The control regions 401 and 402 may be configured as a specific subband 403 in a total system bandwidth 410 on the frequency axis. One or more OFDM symbols may be configured on the time axis, which may be defined as a control resource set duration 404. Referring to FIG. 4, control region #1 401 is set to a control region length of two symbols, and control region #2 402 is set to a control region length of one symbol.

Referring to FIG. 4, a control region in 5G may be configured for a terminal through higher layer signaling (e.g., system information, a Master Information Block (MIB), or RRC signaling) by a base station. Configuring a control region for a terminal may mean providing information such as the location of the control region, a subband, resource allocation of the control region, the length of the control region, and the like. For example, the information may include information disclosed in Table 2.

TABLE 2
- - Configuration information 1. frequency-axis RB allocation
information
- - Configuration information 2. starting symbol of control region
- - Configuration information 3. symbol length of control region
- - Configuration information 4. REG bundling size (2 or 3 or 6)
- - Configuration information 5. transmission mode (interleaved
transmission scheme or non-interleaved transmission scheme)
- - Configuration information 6. DMRS configuration information
(precoder granularity)
- - Configuration information 7. search space type (common search
space, group-common search space, terminal-specific search space)
- - Configuration information 8. DCI format to monitor in corresponding
control region
- - Others

In addition to the above configuration information, various other information required to transmit the DL control channel may be configured for the terminal.

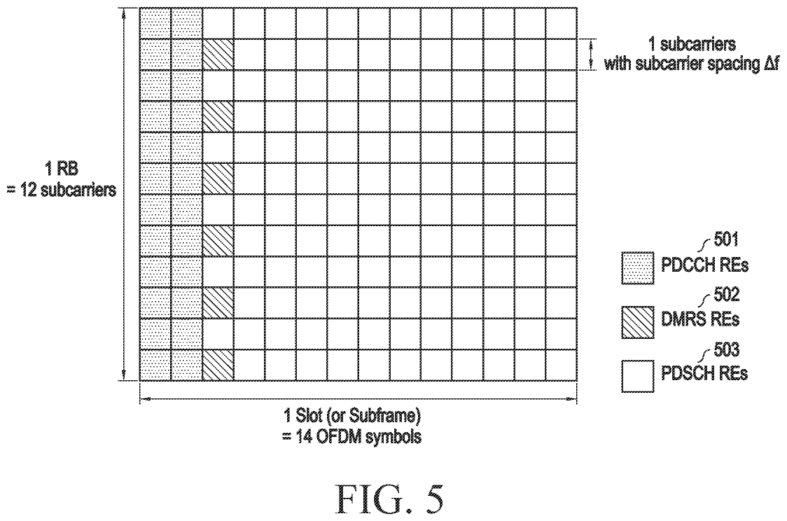

FIG. 5 is a diagram illustrating an exemplary DL RB structure in 5G according to various embodiments of the disclosure. Referring to FIG. 5, scheduling information for a Physical Uplink Shared CHannel (PUSCH) or a Physical Downlink Shared CHannel (PDSCH) is transmitted in DCI from a base station to a terminal in a 5G system. The terminal may monitor a fallback DCI format and a non-fallback DCI format for the PUSCH or the PDSCH. The fallback DCI format may include fixed fields between the base station and the terminal, whereas the non-fallback DCI format may include configurable fields.

For example, fall-back DCI that schedules the PUSCH may include information disclosed in Table 3.

TABLE 3

- Identifier for DCI formats - [1] bit
- Frequency domain resource assignment -
[┌log₂(N_{RB}^{UL,BWP}(N_{RB}^{UL,BWP}+1)/2)┐ ] bits
- Time domain resource assignment - X bits
- Frequency hopping flag - 1 bit.
- Modulation and coding scheme - [5] bits
- New data indicator - 1 bit
- Redundancy version - [2] bits
- HARQ process number - [4] bits
- TPC command for scheduled PUSCH - [2] bits
- UL/SUL indicator - 0 or 1 bit

For example, non-fallback DCI that schedules the PUSCH may include information disclosed in Table 4.

TABLE 4

| - | Carrier indicator - 0 or 3 bits | | |
|---|---|---|---|
| - | Identifier for DCI formats - [1] bits | | |
| - | Bandwidth part indicator - 0, 1 or 2 bits | | |
| - | Frequency domain resource assignment | | |
| | | • | For resource allocation type 0, ┌N_{RB}^{UL, BWP}/P┐ bits |
| | | • | For resource allocation type 1, ┌log₂(N_{RB}^{UL, BWP} (N_{RB}^{UL, BWP} + 1)/2)┐ bits |
| - | Time domain resource assignment -1, 2, 3, or 4 bits | | |
| - | VRB-to-PRB mapping - 0 or 1 bit, only for resource allocation type 1. | | |
| | | • | 0 bit if only resource allocation type 0 is configured; |
| | | • | 1 bit otherwise. |
| - | Frequency hopping flag - 0 or 1 bit, only for resource allocation type 1. | | |
| | | • | 0 bit if only resource allocation type 0 is configured; |
| | | • | 1 bit otherwise. |
| - | Modulation and coding scheme - 5 bits | | |
| - | New data indicator - 1 bit | | |
| - | Redundancy version - 2 bits as defined in section x.x of [6, TS38.214] | | |
| - | HARQ process number - 4 bits | | |
| - | 1st downlink assignment index - 1 or 2 bits | | |
| | | • | 1 bit for semi-static HARQ-ACK codebook; |
| | | • | 2 bits for dynamic HARQ-ACK codebook with single HARQ-ACK codebook. |
| - | 2nd downlink assignment index - 0 or 2 bits | | |
| | | • | 2 bits for dynamic HARQ-ACK codebook with two HARQ-ACK sub-codebooks; |
| | | • | 0 bit otherwise. |
| - | TPC command for scheduled PUSCH 2 bits | | |
| - | $SRS resource indicator - ⌈ {log}_{2} ( {\sum }_{k = 1}^{{L}_{max}} ( \begin{matrix}{N}_{SRS} \\ k\end{matrix} ) ) ⌉ or ⌈ {log}_{2} ( {N}_{SRS} ) ⌉ bits$ | | |
| | | • | $⌈ {log}_{2} ( {\sum }_{k = 1}^{{L}_{max}} ( \begin{matrix}{N}_{SRS} \\ k\end{matrix} ) ) ⌉ bits for non - codebook based PUSCH transmission ;$ |
| | | • | ┌log₂(N_{SRS})┐ bits for codebook based PUSCH transmission. |

| | |
|---|---|
| - | Precoding information and number of layers -up to 6 bits |
| - | Antenna ports - up to 5 bits |
| - | SRS request - 2 bits |
| - | CSI request - 0, 1, 2, 3, 4, 5, or 6 bits |
| - | CBG transmission information - 0, 2, 4, 6, or 8 bits |
| - | PTRS-DMRS association - 2 bits. |
| - | beta_offset indicator - 2 bits |
| - | DMRS sequence initialization - 0 or 1 bit |
| - | UL/SUL indicator - 0 or 1 bit |

For example, fallback DCI that schedules the PDSCH may include information disclosed in Table 5.

TABLE 5

- Identifier for DCI formats - [1] bit
- Frequency domain resource assignment -
[┌log₂(N_{RB}^{DL,BWP}(N_{RB}^{DL,BWP}+1)/2)┐ ] bits
- Time domain resource assignment - X bits
- VRB-to-PRB mapping - 1 bit,
- Modulation and coding scheme - [5] bits
- New data indicator - 1 bit
- Redundancy version - [2] bits
- HARQ process number - [4] bits
- Downlink assignment index - 2 bits
- TPC command for scheduled PUCCH - [2] bits
- PUCCH resource indicator - [2] bits
- PDSCH-to-HARQ feedback timing indicator - [3] bits

For example, non-fallback DCI that schedules the PDSCH may include information disclosed in Table 6.

```
TABLE 6
- Carrier indicator - 0 or 3 bits
- Identifier for DCI formats - [1] bits
- Bandwidth part indicator - 0, 1 or 2 bits
- Frequency domain resource assignment
  • For resource allocation type 0, ┌N_{RB}^{DL,BWP} / P┐ bits
  • For resource allocation type 1, ┌log₂(N_{RB}^{DL,BWP}(N_{RB}^{DL,BWP} + 1)/ 2)┐
bits
- Time domain resource assignment -1, 2, 3, or 4 bits
- VRB-to-PRB mapping - 0 or 1 bit, only for resource allocation type 1.
  • 0 bit if only resource allocation type 0 is configured;
  • 1 bit otherwise.
- PRB bundling size indicator - 1 bit
- Rate matching indicator - 0, 1, 2 bits
- ZP CSI-RS trigger - X bits
For transport block 1:
- Modulation and coding scheme - 5 bits
- New data indicator - 1 bit
- Redundancy version - 2 bits
For transport block 2:
- Modulation and coding scheme - 5 bits
- New data indicator - 1 bit
- Redundancy version - 2 bits
- HARQ process number - 4 bits
- Downlink assignment index - 0 or 4 bits
- TPC command for scheduled PUCCH 2 bits
- PUCCH resource indicator
- PDSCH-to-HARQ_feedback timing indicator - 3 bits
- Antenna ports - up to 5 bits
- Transmission configuration indication - 3 bits
- SRS request - 2 bits
- CBG transmission information - 0, 2, 4, 6, or 8 bits
- CBG flushing out information - 0 or 1 bit
- DMRS sequence initialization - 0 or 1 bit
```

The DCI may be transmitted on a DL physical control channel, Physical Downlink Control CHannel (PDCCH) after channel coding and modulation. DCI message payload is attached with a Cyclic Redundancy Check (CRC), which is scrambled with an RNTI a Radio Network Temporary Identifier (RNTI) corresponding to the identity of the terminal. Different RNTIs are used depending on the purpose of the DCI message, for example, terminal-specific (UE-specific) data transmission, a power control command, or a random access response. That is, the RNTI is not transmitted explicitly but is included in CRC calculation. Upon receipt of the DCI message transmitted on the PDCCH, the terminal may check the CRC using an assigned RNTI, and when the CRC check is correct, know that the message is directed to the terminal.

According to an embodiment, DCI that schedules a PDSCH for system information (SI) may be scrambled with an SI-RNTI. For example, DCI that schedules a PDSCH for a random access response (RAR) message may be scrambled with an RA-RNTI. For example, DCI that schedules a PDSCH for a paging message may be scrambled with a P-RNTI. For example, DCI that indicates a slot format indicator (SFI) may be scrambled with an SFI-RNTI. For example, DCI that indicates transmit power control (TPC) may be scrambled with a TPC-RNTI. For example, DCI that schedules a terminal-specific PDSCH or PUSCH may be scrambled with a cell RNTI (C-RNTI).

Referring to FIG. 5, when a specific terminals scheduled for a data channel, for example, a PUSCH or a PDSCH by a PDCCH, data is transmitted and received with a DMRS in a corresponding scheduled resource area.

Referring to FIG. 5, it is shown that a specific terminal is configured to use 14 OFDM symbols as one slot (or subframe) on DL, with a PDCCH transmitted in first two OFDM symbols 501 and a DMRS transmitted in a third symbol 502. In a specific RB in which the PDSCH is scheduled, the PDSCH may be transmitted with data mapped to REs carrying no DMRS in the third symbol and REs in the following fourth to last symbols 503. According to an embodiment of the disclosure, a subcarrier spacing Δf is 15 kHz in the LTE/LTE-A system and one of {15, 30, 60, 120, 240, 480} kHz in the 5G system.

According to an embodiment, to measure a DL channel state in a wireless communication system, a base station needs to transmit an RS. In the case of the 3GPP Long Term Evolution Advanced (LTE-A) system, a CRS or CSI-RS transmitted by a base station allows a terminal to measure a channel state between the base station and the terminal. The channel state needs to be measured in consideration of various factors, which may include DL interference. The DL interference includes an interference signal and thermal noise generated by an antenna belonging to a neighboring base station, and is important for the terminal to determine the DL channel state. For example, when a base station with a single transmission antenna transmits a signal to a terminal with a single reception antenna, the terminal needs to determine Es/Io by determining energy per symbol receivable on DL from an RS received from the base station and interference to be received simultaneously in a period in which a corresponding symbol is received. The determined Es/Io is converted to a data rate or its equivalent value and transmitted to the base station in the form of a channel quality indicator (CQI), which may be used to determine a data rate at which the base station needs to transmit to the terminal.

According to an embodiment, in the case of the LTE-A system, the terminal may feed back DL channel state information to the base station so that the base station uses the DL channel state information for DL scheduling. For example, the terminal measures an RS transmitted on DL by the base station and feeds back information extracted from the measurement to the base station in a form defined by the LTE/LTE-A standard. As described above, the information fed back by the terminal in LTE/LTE-A may be referred to as channel state information, which may include the following three types of information.

Rank indicator (RI): The number of spatial layers that a terminal is capable of receiving in a current channel state.

Precoding matrix indicator (PMI): An indicator of a precoding matrix that a terminal prefers to use in a current channel state.

Channel quality indicator (CQI): A maximum data rate at which a terminal is capable of receiving in a current channel state.

The CQI may be replaced by a signal to interference plus noise ratio (SINR) which may be used similarly to a maximum data rate, a maximum error correction code rate and modulation scheme, data efficiency per frequency, and so on.

According to an embodiment, an RI, a PMI, and a CQI included in channel state information have meanings in correlation with each other. For example, because a precoding matrix supported in LTE/LTE-A is defined differently for each rank, a PMI value X may be interpreted differently when the RI has a value of 1 and when the RI has a value of 2.

According to an embodiment, when the terminal determines a CQI, it assumes that a PMI and X that it has reported to the base station have been applied by the base station. For example, reporting RI_X, PMI_Y, and CQI_Z to the base station by the terminal amounts to reporting that the terminal is capable of receiving a data rate corresponding to CQI_Z, when the rank is RI_X and the PMI is PMI_Y. In this way, the terminal assumes a transmission scheme to be performed in the base station in calculating a CQI to obtain optimized performance when actual transmission is performed in the transmission scheme.

According to an embodiment, the terminal may feed back an RI, a PMI, and a CQI as channel state information periodically or aperiodically in LTE/LTE-A. When the base station wants to aperiodically obtain channel state information about a specific terminal, the base station may configure the terminal to perform an aperiodic feedback (or aperiodic channel state information reporting) using an aperiodic feedback indicator (or channel state information request field or channel state information request information) included in Downlink Control Information (DCI) for the terminal. Further, when receiving an indicator set to indicate an aperiodic feedback in an n^{th} subframe, the terminal may perform UL transmission by including aperiodic feedback information (or channel state information) in the data transmission in an (n+k)^{th} subframe. Herein, k is a parameter defined in the 3GPP LTE Release 11 standard, which is 4 in frequency division duplexing (FDD) and may be defined in time division duplexing (TDD) as shown in Table 7.

TABLE 7

| TDD UL/DL | subframe number n | | | | | | | | | |
|---|---|---|---|---|---|---|---|---|---|---|
| Configuration | 0 | 1 | 2 | 3 | 4 | 5 | 6 | 7 | 8 | 9 |
| 0 | — | — | 6 | 7 | 4 | — | — | 6 | 7 | 4 |
| 1 | — | — | 6 | 4 | — | — | — | 6 | 4 | — |
| 2 | — | — | 4 | — | — | — | — | 4 | — | — |
| 3 | — | — | 4 | 4 | 4 | — | — | — | — | — |
| 4 | — | — | 4 | 4 | — | — | — | — | — | — |
| 5 | — | — | 4 | — | — | — | — | — | — | — |
| 6 | — | — | 7 | 7 | 5 | — | — | 7 | 7 | — |

When aperiodic feedback is set, the feedback information (or channel state information) includes an RI, a PMI, and a CQI, and the RI and the PMI may not be fed back depending on a feedback configuration (or a channel state reporting configuration).

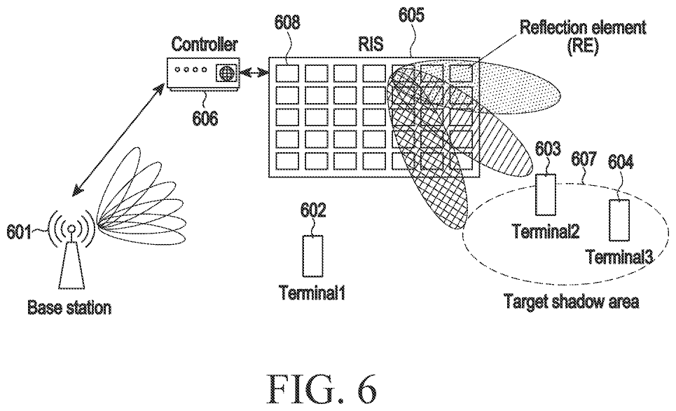

FIG. 6 is a diagram schematically illustrating a structure of a wireless communication system including a Reconfigurable Intelligent Surface (RIS) according to various embodiments of the disclosure.

Referring to FIG. 6, a wireless communication system 600 may include a base station 601, a terminal 1 602, a terminal 2 603, a terminal 3 604, an RIS 605, and an RIS Controller (RC) 606. According to an embodiment, the base station 601 supporting a plurality of beams may perform a wireless communication with the terminal 1 602 located outside a shadow area without the help of the RIS 605. According to an embodiment, the base station 601 supporting the plurality of beams may perform a wireless communication with the terminal 2 603 and the terminal 3 604 which are located at a shadow area 607 via the RIS 605. According to an embodiment, the base station 601 may transfer a control signal for controlling the RIS 605 to the RC 606 in order to perform the wireless communication with the terminals 603 and 604 located at the shadow area 607. According to an embodiment, the RIS 605 may reflect, to the terminals 603, 604 located at the shadow area 607, at least one beam directed to the RIS 605 among a plurality of beams of the base station 601 for performing the wireless communication with the terminals 603, 604 located at the shadow area 607 using the control signal received from the RC 608. At this time, the control signal may include information about at least one reflection pattern of a plurality of reflection patterns of the RIS 605 for performing the wireless communication with the terminals 603 and 604 in the shadow area 607. According to an embodiment, the terminals 603 and 604 located at the shadow area 607 may perform a wireless communication with the base station 601 using the same beam and the same reflection pattern as at least one beam and at least one reflection pattern which are directed to the shadow area 607 among the plurality of beams of the base station 601 and the plurality of reflection patterns of the RIS 605.

According to an embodiment, the RC 606 may be a general terminal (e.g., an NR terminal, an LTE terminal, an NB-IoT, an MTC terminal, etc.) connected to the base station 601 through in-band or out-band. At this time, being connected through the in-band means that the RC 606 is connected to the base station 601 in the same band as a band in which the terminals 603 and 604 located at the shadow area 607 communicate with the base station 601, and being connected through the out-band means that the RC 606 is connected to the base station 601 in a band different from the band in which the terminals 603 and 604 located at the shadow area 607 communicate with the base station 601. If the RC 606 is connected to the base station 601 through the in-band or the out-band, the control signal may be transferred from the base station 601 to the RC 606 via a control channel (e.g., a PDCCH). According to another embodiment, the control signal may be transferred from the base station 601 to the RC 606 via the control channel (e.g., the PDCCH) or an RC-dedicated control channel defined for control of the RC. According to still another embodiment, the control signal may be transferred from the base station 601 to the RC 606 via RRC. According to another embodiment, the RC 606 may be connected to the base station 601 via another communication scheme (e.g., Wi-Fi, Bluetooth, wireline, etc.). If the RC 606 is connected to the base station 601 via the other communication scheme, the control signal may be transferred from the base station 601 to the RC 606 via, for example, a payload.

According to an embodiment, the RIS 606 may be composed of a plurality (e.g., N) of reflection elements (REs) 608 and may support a plurality (e.g., P) of reflection patterns. At this time, a reflection pattern may be defined as a combination of reflection phases and/or reflection amplitudes of the plurality of REs. For example, when the pth reflection pattern is Θₚ, Θₚ may be expressed as follows.

$${Θ}_{p} = \{ {β}_{p , 1} {e}^{j {θ}_{p , 1}} , {β}_{p , 2} z {e}^{j {θ}_{p , 2}} , {β}_{p , 3} {e}^{j {θ}_{p , 3}} , … , {β}_{p , N} {e}^{j {θ}_{p , N}} \} p ∈ \{ 1 , 2 , … , P \}$$

Here, an element

$${β}_{p , i} \text{?}$$

$$\text{?} \text{indicates text missing or illegible when filed}$$

(1≤i≤N) of the p-th reflection pattern represents a combination of a reflection phase (θ_{p,i}) and a reflection amplitude (β_{p,i}) by the i-th RE 608 of the RIS 605.

In an embodiment in FIG. 6, a case that the two terminals 603 and 604 are located within a target shadow area 607 and the one terminal 602 exists outside the target shadow area 607 has been described, however, the number of terminals located inside/outside the target shadow area is not limited to this. For example, embodiments of the disclosure may be also applied to a case that one terminal or a plurality of terminals are located within the target shadow area 607.

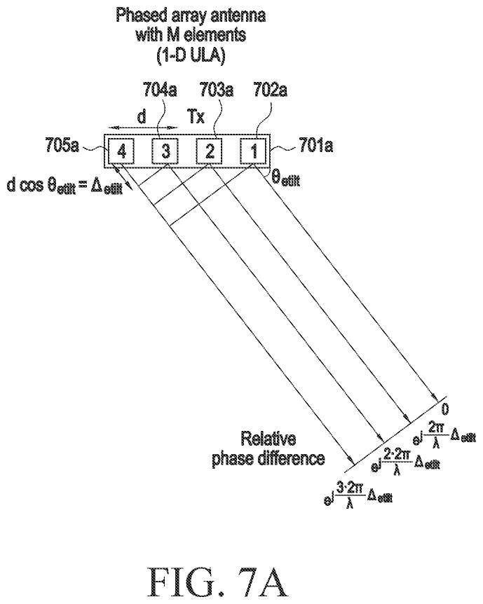

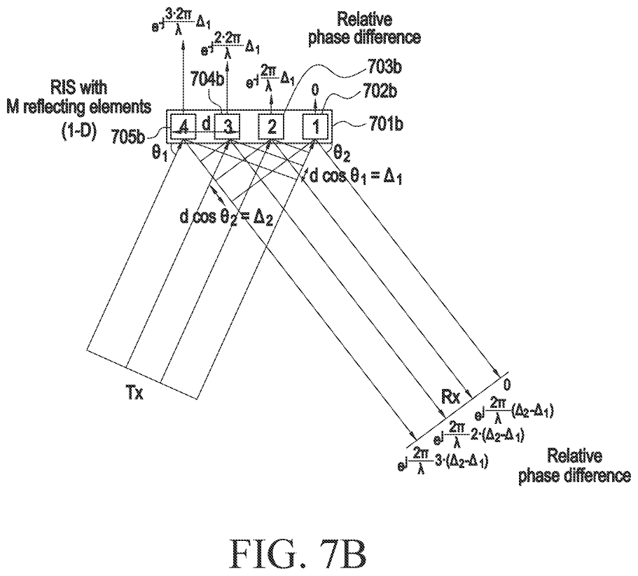

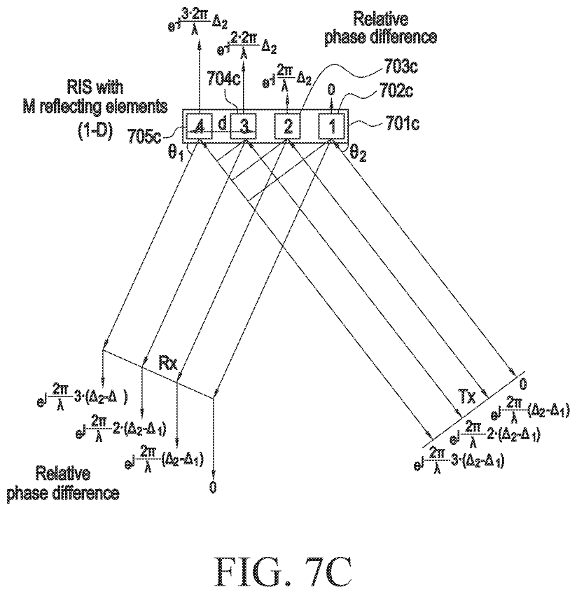

FIGS. 7A to 7C are diagrams for explaining an operating principle of an RIS according to various embodiments of the disclosure. FIG. 7A is a diagram for explaining a beamforming scheme of a phase array antenna, FIG. 7B is a diagram for explaining a reflection pattern and a reflection direction of an RIS, and FIG. 7C is a diagram for explaining correspondence relation in a forward link and a reverse link of an RIS reflection pattern.

Referring to FIG. 7A, an antenna array 701a may include a plurality of antenna elements 702a, 703a, 704a, and 705a. According to an embodiment, the plurality of antenna elements 702a, 703a, 704a, and 705a may be spaced apart at the same interval (d). For example, the first antenna element 702a and the second antenna element 703a may be spaced apart at the interval (d), the second antenna element 703a and the third antenna element 704a may be spaced apart at the interval (d), and the third antenna element 704a and the fourth antenna element 705a may be spaced apart at the interval (d). Although FIG. 7A shows four antenna elements, there is no limitation to the number of antenna elements, and the beamforming scheme in FIG. 7A may be applied to arbitrary antenna elements.

According to an embodiment, if a beam is formed in a specific direction (θₑₜᵢₗₜ) via the antenna array 701a, a relative phase difference among the antenna elements 702a, 703a, 704a, and 705 may occur in the direction θₑₜᵢₗₜ according to a structure of the antenna array 701a. For example, a transmission beam of the fourth antenna element 705a moves further by a distance corresponding to d cos θₑₜᵢₗₜ (=Δₑₜᵢₗₜ) in the direction θₑₜᵢₗₜ compared to a transmission beam of the third antenna element 704a, the transmission beam of the fourth antenna element 705a moves further by a distance corresponding to 2θₑₜᵢₗₜ in the direction θₑₜᵢₗₜ compared to a transmission beam of the second antenna element 703a, and the transmission beam of the fourth antenna element 705a moves further by a distance corresponding to 3Δₑₜᵢₗₜ in the direction θₑₜᵢₗₜ compared to a transmission beam of the first antenna element 702a. So, when a phase of the first antenna element 702a in the direction θₑₜᵢₗₜ is assumed to be 0, The second antenna element 703a, the third antenna element 704a, and the fourth antenna element 705a have relative phase differences

$${e}^{j \frac{2 π}{λ} {Δ}_{etilt}} ,$$

$${e}^{j \frac{2 \cdot 2 π}{λ} {Δ}_{etilt}} ,$$

$$and$$

$${e}^{j \frac{3 \cdot 2 π}{λ} {Δ}_{etilt}} ,$$

respectively, compared with the phase of the first antenna element 702a. Here, λ represents a wavelength of the transmission beams of respective antenna elements 702a, 703a, 704a, and 705a. According to an embodiment, the antenna array 701a may set a phase shift value of each of the antenna elements 702a, 703a, 704a, and 705a to compensate for the relative phase difference among the antenna elements 702a, 703a, 704a, and 705a.

Referring to FIG. 7B, an RIS 701b may include a plurality of REs 702b, 703b, 704b, and 705b. According to an embodiment, the plurality of REs 702b, 703b, 704b, and 705b may be spaced apart at the same interval (d). For example, the first RE 702b and the second RE 703b may be spaced apart at the interval (d), the second RE 703b and the third RE 704b may be spaced apart at the interval (d), and the third RE 704b and the fourth RE 705b may be spaced apart at the interval (d). Although FIG. 7B shows four REs, there is no limitation to the number of REs, and the reflection pattern and the reflection direction scheme in FIG. 7B may be applied to arbitrary number of REs.

According to an embodiment, the RIS 701b, unlike an antenna array (e.g., an antenna array 701b in FIG. 7A) which transmits a transmission beam itself, performs only a role of reflecting a transmission beam which is directed to the RIS 701b, so the RIS 701b needs to compensate for a relative phase difference among respective REs 702b, 703b, 704b, and 705b which occurs according to a structure of the RIS 701b by considering all of a specific direction (θ₁) of the transmission beam which is directed to the RIS and a specific direction (θ₂) in which the corresponding transmission beam is reflected. For example, a transmission beam directed to the first RE 702b moves further by a distance corresponding to d cos θ₁ (=Δ₁) in the direction θ₁ compared to a transmission beam directed to the second RE 703b, the transmission beam directed to the first RE 702b moves further by a distance corresponding to 2Δ₁ in the direction θ₁ compared to a transmission beam directed to the third RE 704b, and the transmission beam directed to the first RE 702b moves further by a distance corresponding to 3Δ₁ in the direction θ₁ compared to a transmission beam directed to the fourth RE 705b. A beam reflected from the fourth RE 705b moves further by a distance corresponding to d cos θ₂ (=Δ₂) in the direction θ₂ compared to a beam reflected from the third RE 704b, the beam reflected from the fourth RE 705b moves further by a distance corresponding to 2Δ₂ in the direction θ₂ compared to a beam reflected from the second RE 703b, and the beam reflected from the fourth RE 705b moves further by a distance corresponding to 3Δ₂ in the direction θ₂ compared to a beam reflected from the first RE 702b. So, when a phase of the first RE 702b in the direction θ₂ is assumed to be 0, the second RE 703b, the third RE 704b, and the fourth RE 705b have relative phase differences

$${e}^{j \frac{2 π}{λ} ( {Δ}_{2} - {Δ}_{1} )} ,$$

$${e}^{j \frac{2 \cdot 2 π}{λ} ( {Δ}_{2} - {Δ}_{1} )} ,$$

$$and$$

$${e}^{j \frac{3 \cdot 2 π}{λ} ( {Δ}_{2} - {Δ}_{1} )} ,$$

respectively, compared to the phase of the first RE 702b. Here, ˜ represents a wavelength of the transmission beams directed to the respective REs 702b, 703b, 704b, and 705b and the beams reflected by of the respective REs 702b, 703b, 704b, and 705b. According to an embodiment, the RIS 701b may set a phase shift value of the respective REs 702b, 703b, 704b, and 705b to compensate for a relative phase difference among the REs 702b, 703b, 704b, and 705b.

Referring to FIG. 7C, an RIS 701c may include a plurality of REs 702c, 703c, 704c, and 705c. According to an embodiment, the plurality of REs 702c, 703c, 704c, and 705c may be spaced apart at the same interval (d). For example, the first RE 702c and the second RE 703c may be spaced apart at the interval (d), the second RE 703c and the third RE 704c may be spaced apart at the interval (d), and the third RE 704c and the fourth RE 705c may be spaced apart at the interval (d). Although FIG. 7C shows four REs, there is no limitation to the number of REs, and a correspondence-relation scheme in a forward link and a reverse link in FIG. 7C may be applied to arbitrary number of REs.

According to an embodiment, if channel reciprocity is established, the same phase change may occur in a forward link channel from a base station to a terminal in a shadow area and a reverse link channel from the terminal in the shadow area to the base station. For example, assuming a specific direction (θ₂) of a transmission beam from the terminal in the shadow area to the RIS 701c and a specific direction (θ₁) in which the corresponding transmission beam is reflected to the base station, a relative phase difference of respective REs 701c, 702c, 704c, and 705c satisfies

$${e}^{j \frac{2 π}{λ} ( {Δ}_{2} - {Δ}_{1} )} ,$$

$${e}^{j \frac{2 \cdot 2 π}{λ} ( {Δ}_{2} - {Δ}_{1} )} ,$$

$$and$$

$${e}^{j \frac{3 \cdot 2 π}{λ} ( {Δ}_{2} - {Δ}_{1} )} ,$$

which are the same as a relative phase difference of respective REs in a forward link channel in FIG. 7B. According to an embodiment, the RIS 701c may set a phase shift value of the respective REs 702c, 703c, 704c, and 705c to compensate for the relative phase difference among the REs 702c, 703c, 704c, and 705c.

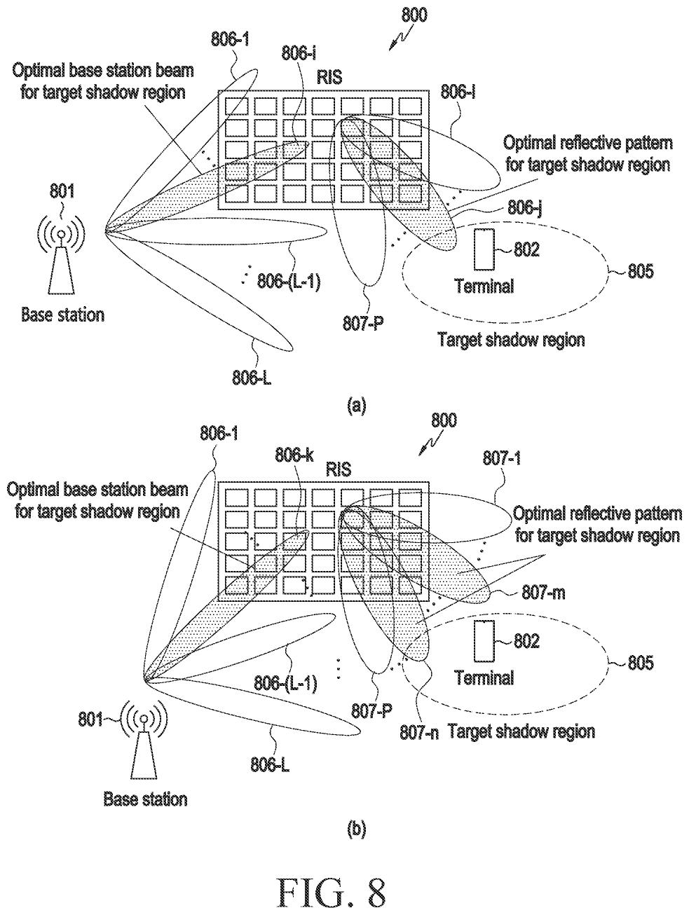

FIG. 8 is a diagram for explaining an optimal beam of a base station and an optimal reflection pattern of an RIS for a target shadow area, according to various embodiments of the disclosure. (a) in FIG. 8 is a diagram illustrating a case that there is an optimal reflection pattern of one RIS associated with an optimal beam of a base station, and (b) in FIG. 8 is a diagram illustrating a case that there are a plurality of optimal reflection patterns of a plurality of RISs associated with the optimal beam of the base station.

Referring to (a) in FIG. 8, a base station 801 in a wireless communication system 800 may communicate with a terminal 802 located in a target shadow area 805 via the i (1≤i≤L)th transmission beam 806-i among L transmission beams 806 and the j (1≤j≤P)th reflection beam 807-j among P reflection beams 807 according to P reflection patterns of an RIS 803. At this time, if communication quality between the base station 801 and the terminal 802 via a combination of the i-th transmission beam 806-i and the j-th reflection beam 807-j among a plurality of transmission beam-reflection beam combinations is the best, the i-th transmission beam 806-i may be an optimal beam of the base station 801 for the target shadow area 805, and the j-th reflection pattern corresponding to the j-th reflection beam 806-j may be an optimal reflection pattern of an RIS 803 for the shadow area 805.

Referring to (b) in FIG. 8, a base station 801 in a wireless communication system 800 may communicate with a terminal 802 located in a target shadow area 805 via the k (1≤k≤L)th transmission beam 806-k among L transmission beams 806 and the m (1≤m≤P)th reflection beam 807-m and the n (1≤n≤P, n≠m)th reflection beam 807-n among P reflection beams 807 according to P reflection patterns of an RIS 803. At this time, if communication quality between the base station 801 and the terminal 802 via the k-th transmission beam 806-k, the m-th reflection beam 807-m, and the n-th reflection beam 807-n among a plurality of transmission beam-reflection beam combinations is the best, the k-th transmission beam 806-k may be an optimal beam of the base station 801 for the target shadow area 805, and the m-th reflection pattern corresponding to the m-th reflection beam 806-m and the n-th reflection pattern corresponding to the n-th reflection beam 806-n may be an optimal reflection pattern of the RIS 803 for the shadow area 805.

In (a) and (b) in FIG. 8, if a beam of the base station is different for the same reflection pattern, a direction of reflection by the RIS may be different. Further, if locations of shadow areas are different for the same beam of the base station in (a) and (b) in FIG. 8, different reflection patterns may be required for respective shadow areas. Further, if a location of the RIS changes for the same shadow area in (a) and (b) in FIG. 8, a beam of the base station and a reflection pattern of the RIS for the corresponding shadow area may change. That is, according to the locations of the base station and the RIS, and the location of the shadow area, an optimal beam of the base station and an optimal reflection pattern(s) of the RIS for the base station to communicate with the shadow area may be different.

The disclosure proposes methods for obtaining an optimal beam of a base station and an optimal reflection pattern of an RIS for the base station to communicate with a terminal located in a shadow area, according to locations of the base station and the RIS, and a location of the shadow area. Hereinafter, specific embodiments of the methods for obtaining the optimal beam of the base station and the optimal reflection pattern of the RIS for the base station to communicate with the terminal located in the shadow area will be described.

### First Embodiment

The first embodiment of the disclosure relates to an embodiment in which a test terminal located in a target shadow area measures strength of a synchronization signal of a base station and reports this to the base station to obtain an optimal beam of the base station and an optimal reflection pattern of an RIS in the target shadow area.

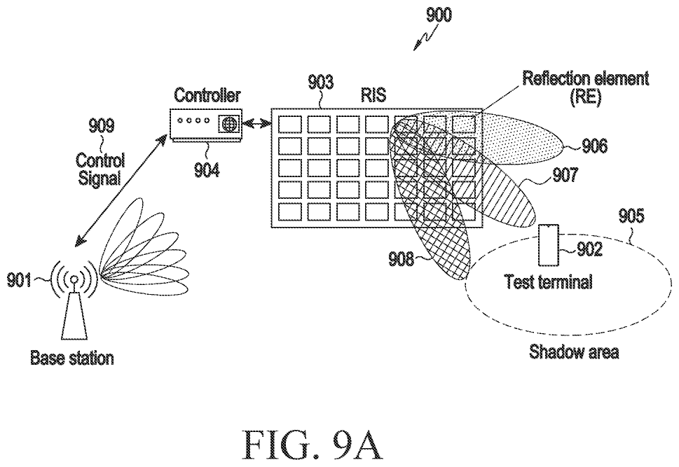

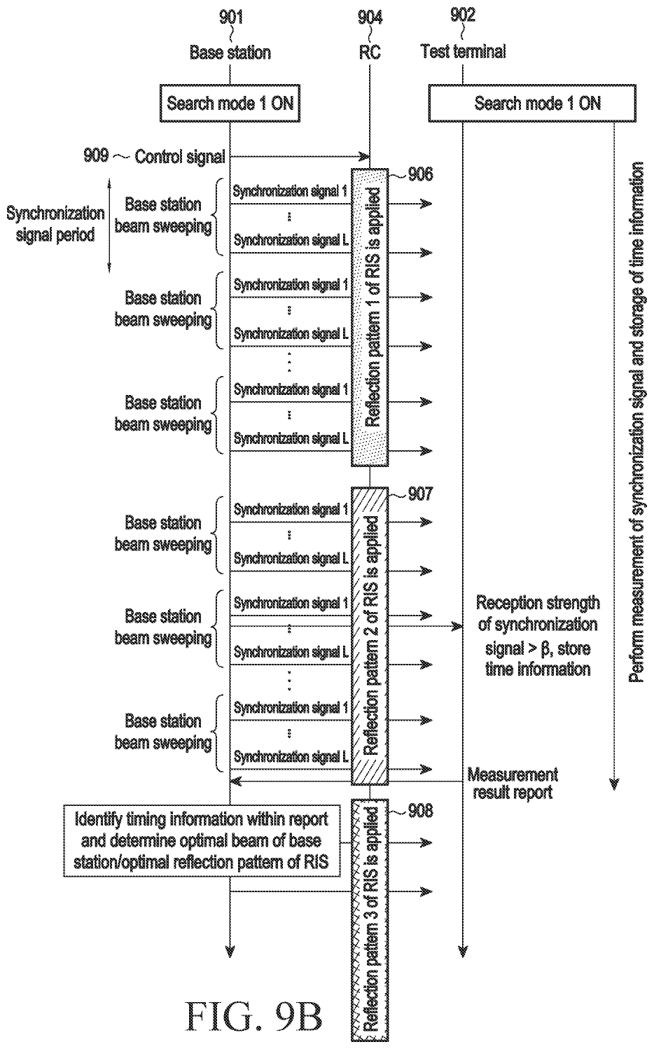

FIGS. 9A and 9B are diagrams for explaining a method of obtaining an optimal beam of a base station and an optimal reflection pattern of an RIS using a measurement result for a synchronization signal of the base station of a test terminal according to the first embodiment of the disclosure. FIG. 9A is a diagram illustrating a wireless communication system according to the first embodiment, and FIG. 9B is a diagram for explaining an operation of a base station and a test terminal according to the first embodiment of the disclosure.

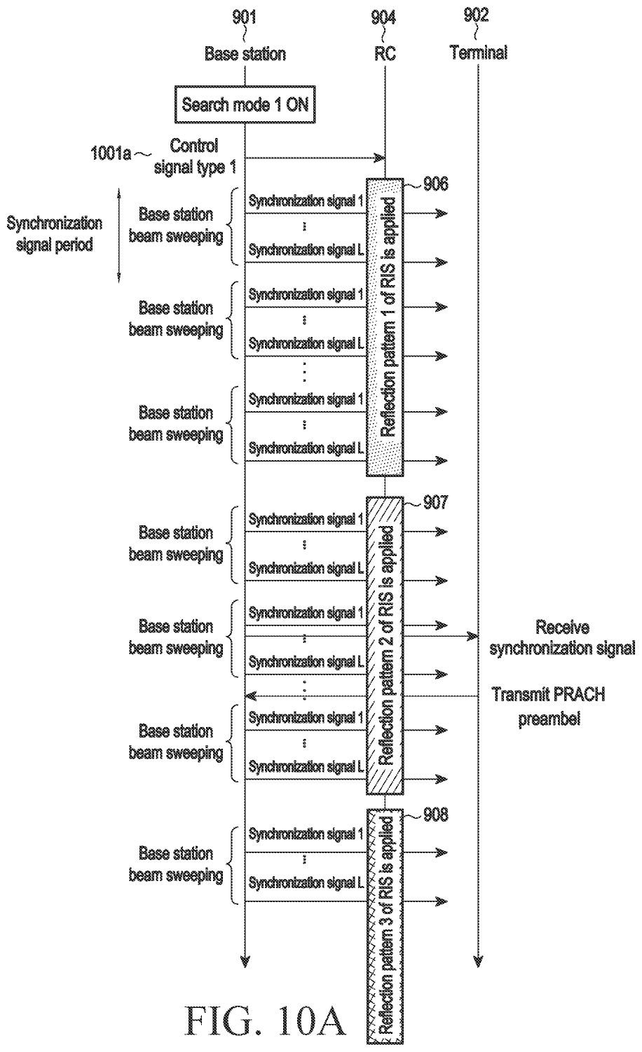

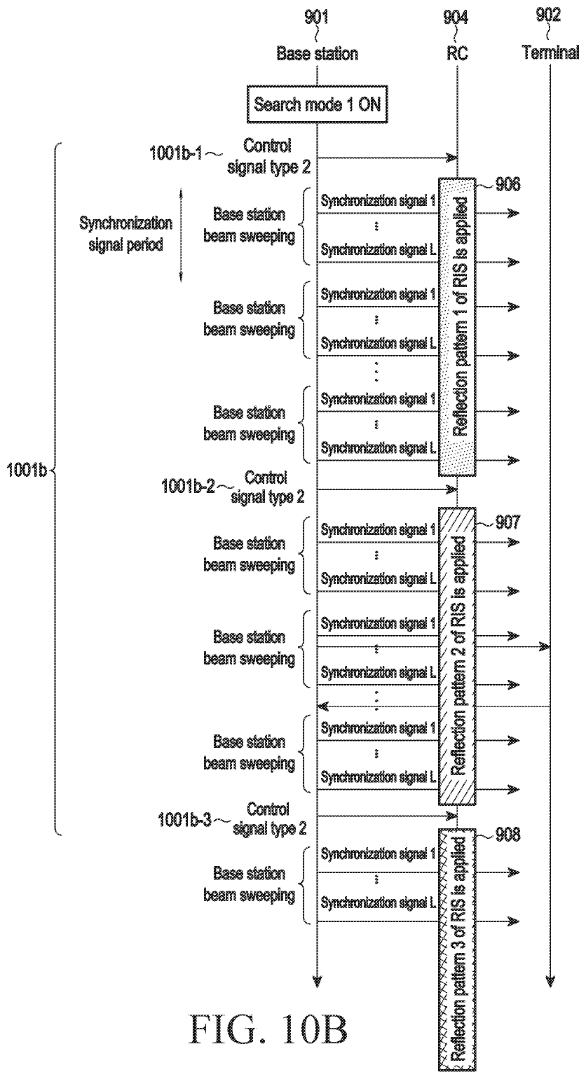

Referring to FIGS. 9A and 9B, in a wireless communication system 900, a base station 901 may transmit, to a test terminal 902 in a target shadow area 905, synchronization signals for each of a plurality of beams (e.g., L beams) in order to obtain an optimal beam of the base station 901 and an optimal reflection pattern of an RIS 903 for the target shadow area 905. The base station 901 may transmit a control signal 909 to an RC 904 so that the RIS 903 applies a specific reflection pattern, for example, one of the first reflection pattern 906, the second reflection pattern 907, and the third reflection pattern 908 during a time interval consisting of a single or a plurality of synchronization signal periods. A detailed description of the control signal will be described later with reference to FIG. 10.

According to an embodiment, the test terminal 902 located in the target shadow area 905 may receive the synchronization signals for each of the plurality of beams of the base station 901 via beams generated by reflecting the plurality of beams of the base station 901 by a plurality of reflection patterns of the RIS 903. According to an embodiment, the test terminal 902 may measure reception strength (e.g., reference signal received power (RSRP)) of synchronization signals for each of beams generated by reflecting the plurality of beams of the base station 901 by the specific reflection pattern, for example, the one of the first reflection pattern 906, the second reflection pattern 907, and the third reflection pattern 908 during the time interval consisting of the single or the plurality of synchronization signal periods. In this way, the test terminal 902, which measures the reception strength of the synchronization signals for each of the plurality of beams of the base station 901 for all reflection patterns of the RIS 903, may identify information about a corresponding reflection pattern in which reception strength of a synchronization signal for each of the plurality of beams of the base station satisfies a specific threshold value (β) or more for each reflection pattern of the RIS 903 and timing at which the corresponding synchronization signal is measured, and may store the corresponding information. According to an embodiment, the test terminal 902 may transfer, to the base station 901, a measurement report including the information about the corresponding reflection pattern in which the reception strength of the synchronization signal for each of the plurality of beams of the base station satisfies the specific threshold value (β) or more for each reflection pattern of the RIS 903 and the timing at which the corresponding synchronization signal is measured. At this time, the information about the timing may include time information which is based on a global positioning system (GPS). According to an embodiment, the measurement report may be manually transferred to the base station 901 without a separate connection between the base station 901 and the test terminal 902. For example, an operator of the base station 901 and/or the RIS 903 may directly transfer the information about the timing stored in the test terminal 902 to the base station 901. According to another embodiment, the measurement report may be transferred to the base station 901 via a separate connection channel between the base station 901 and the test terminal 902.

According to an embodiment, the base station 901, which receives the measurement report including the timing information from the test terminal 902, may determine an optimal beam of the base station 901 and an optimal reflection of the RIS 903 based on the timing information. For example, the base station 901 may determine a beam(s) of the base station 901 corresponding to the timing included in the timing information as the optimal beam(s), and may determine a reflection pattern(s) of the RIS 903 corresponding to the timing included in the timing information as the optimal reflection pattern(s).

According to an embodiment, the base station 901 may set a reflection pattern codebook of the RIS 903 for servicing the target shadow area based on the determined optimal reflection pattern(s) of the RIS 903. For example, the codebook may be composed of a set of the optimal reflection pattern(s) of the RIS 902 determined by the base station 901. According to an embodiment, the base station 901 may utilize a reflection pattern(s) of the RIS 903 within the set codebook to service the target shadow area 905 using the RIS 903.

FIGS. 10A and 10B are diagrams for explaining a method of transmitting a control signal to an RC by a base station in FIG. 9 according to the first embodiment of the disclosure. FIG. 10A is a diagram illustrating an embodiment of transmitting a control signal for setting an application time interval for each of a plurality of reflection patterns of an RIS only once, and FIG. 10B is a diagram illustrating an embodiment of transmitting control signals between time intervals to which each of the plurality of reflection patterns of the RIS is applied.

Referring to FIG. 10A, in a wireless communication system 900, when transmitting synchronization signals for each of a plurality of beams (e.g., L beams) to a test terminal 902 in a target shadow area 905 to obtain an optimal beam of a base station 901 and an optimal reflection pattern of an RIS 903 for the target shadow area 905, the base station 901 may once transmit, to an RC 904, a control signal 1001a in which time intervals to be applied to each of a plurality of reflection patterns of the RIS 903 which are composed of a single or a plurality of synchronization signal periods are configured. For example, when applying the first reflection pattern 906, the second reflection pattern 907, and the third reflection pattern 908 to the RC 904, the base station 901 may transmit the control signal 1001a in which a time interval which needs to be applied for the first reflection pattern 907, a time interval which needs to be applied for the second reflection pattern 907, and a time interval which needs to be applied for the third reflection pattern 208 are configured.

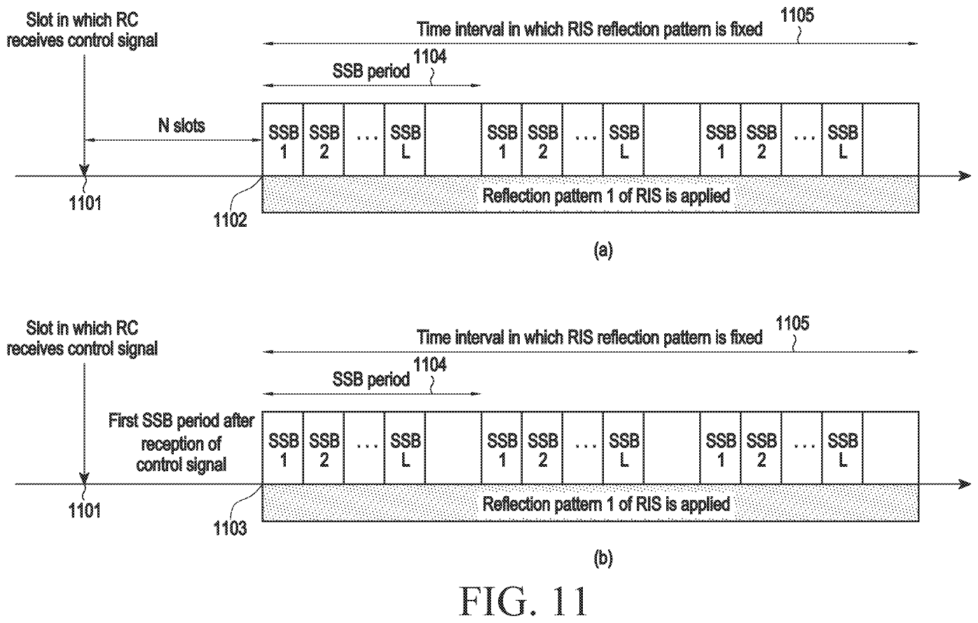

According to an embodiment, the control signal 1001a transmitted from the base station 901 to the RC 904 may include at least one of information about timing at which measurement for obtaining the optimal beam of the base station 901 and the optimal reflection pattern of the RIS 903 for the target shadow area 905, information indicating each of the plurality of reflection patterns of the RIS 903 (e.g., index information indicating a reflection pattern) and information about an order in which the plurality of reflection patterns of the RIS 903 are applied, information about a period (e.g., a beam sweeping period) at which synchronization signals for each of the plurality of beams of the base station 901 are transmitted, and information on the number of times the period at which the synchronization signals for each of the plurality of beams of the base station 901 are transmitted is repeated during a time interval in which a specific reflection pattern is applied. At this time, if information indicating the reflection pattern is the index information indicating the reflection pattern, an index for the corresponding reflection pattern may be defined as p (1≤p≤P) when the corresponding reflection pattern is, for example, Θₚ in FIG. 6. A detailed description of the information about the timing will be described later with reference to FIGS. 11 to 13. A detailed description of the information about the timing will be described later with reference to FIGS. 11 to 13.

According to another embodiment, the control signal 1001a transmitted from the base station 901 to the RC 904 may include at least one of information about timing at which measurement for obtaining the optimal beam of the base station 901 and the optimal reflection pattern of the RIS 903 for the target shadow area 905, information indicating each of the plurality of reflection patterns of the RIS 903 (e.g., index information indicating a reflection pattern) and information about an order in which the plurality of reflection patterns of the RIS 903 are applied, and information about a time interval which needs to be applied for each of the plurality of reflection patterns of the RIS 903. At this time, if information indicating the reflection pattern is the index information indicating the reflection pattern, an index for the corresponding reflection pattern may be defined as p (1≤p≤P) when the corresponding reflection pattern is, for example, Θₚ in FIG. 6. Further, the information about the time interval which needs to be applied for each of the plurality of reflection patterns of the RIS 903 may be represented in a slot unit, a symbol unit, or an absolute time unit (e.g., s, ms, us, etc.). A detailed description of the information about the timing will be described later with reference to FIGS. 11 to 13.

Referring to FIG. 10B, in a wireless communication system 900, when transmitting synchronization signals for each of a plurality of beams (e.g., L beams) to a test terminal 902 in a target shadow area 905 to obtain an optimal beam of a base station 901 and an optimal reflection pattern of an RIS 903 for the target shadow area 905, the base station 901 may transmit, to an RC 904, a control signal 1001b in which a time interval to be applied to a specific reflection pattern of a plurality of reflection patterns of the RIS 903 which is composed of a single or a plurality of synchronization signal periods are configured, whenever applying each of the plurality of reflection patterns. For example, when applying the first reflection pattern 906 to the RC 904, the base station 901 may transmit the first control signal 1001b-1 in which a time interval which needs to be applied for the first reflection pattern 906 is configured, when applying the second reflection pattern 907, the base station 901 may transmit the second control signal 1001b-2 in which a time interval which needs to be applied for the second reflection pattern 907 is configured, and when applying the third reflection pattern 908, the base station 901 may transmit the third control signal 1001b-2 in which a time interval which needs to be applied for the third reflection pattern 908 is configured.

According to an embodiment, the control signal 1001b transmitted from the base station 901 to the RC 904 may include at least one of information about timing at which measurement for obtaining the optimal beam of the base station 901 and the optimal reflection pattern of the RIS 903 for the target shadow area 905, information indicating each of the plurality of reflection patterns of the RIS 903 (e.g., index information indicating a reflection pattern), information about a period (e.g., information about a beam sweeping period of the base station) at which synchronization signals for each of the plurality of beams of the base station 901 are transmitted, and information on the number of times the period at which the synchronization signals for each of the plurality of beams of the base station 901 are transmitted is repeated during a time interval in which a specific reflection pattern is applied. At this time, if information indicating the reflection pattern is the index information indicating the reflection pattern, an index for the corresponding reflection pattern may be defined as p (1≤p≤P) when the corresponding reflection pattern is, for example, Θₚ in FIG. 6. A detailed description of the information about the timing will be described later with reference to FIGS. 11 to 13.

According to another embodiment, the control signal 1001b transmitted from the base station 901 to the RC 904 may include at least one of information about timing at which measurement for obtaining the optimal beam of the base station 901 and the optimal reflection pattern of the RIS 903 for the target shadow area 905, information indicating each of the plurality of reflection patterns of the RIS 903 (e.g., index information indicating a reflection pattern), and information about a time interval which needs to be applied for the specific reflection pattern of the plurality of reflection patterns of the RIS 903. At this time, if information indicating the reflection pattern is the index information indicating the reflection pattern, an index for the corresponding reflection pattern may be defined as p (1≤p≤P) when the corresponding reflection pattern is, for example, Θₚ in FIG. 6. Further, the information about the time interval which needs to be applied for the specific reflection pattern of the plurality of reflection patterns of the RIS 903 may be represented in a slot unit, a symbol unit, or an absolute time unit (e.g., s, ms, μs, etc.). A detailed description of the information about the timing will be described later with reference to FIGS. 11 to 13.

FIG. 11 is a diagram for explaining timing information at which measurement needs to be started to obtain an optimal beam of a base station and an optimal reflection pattern of an RIS in a case that the base station and an RC are connected through in-band according to the first embodiment of the disclosure. (a) and (b) in FIG. 11 are embodiments representing a case that there is an offset between a slot in which the RC receives a control signal and a slot at which measurement needs to be started to obtain the optimal beam of the base station and the optimal reflection pattern of the RIS.

Referring to (a) in FIG. 11, information about timing at which measurement is started to obtain an optimal beam of a base station and an optimal reflection pattern of an RIS included in a control signal may include information about an offset which is configured in a slot unit. For example, a value of the offset may correspond to N slots. According to an embodiment, a time interval 1105 in which a specific reflection pattern among a plurality of reflection patterns of the RIS is applied may start from a time point 1102 after the offset value from a slot 1101 in which an RC receives a control signal, and synchronization signals corresponding to each of a plurality of beams of the base station may be repeatedly transmitted according to a specific period during the time interval 1105 in which the specific reflection pattern is applied. For example, the synchronization signal may be a synchronization signal block (SSB) signal, and the base station may map each of L beams to L SSB signals for beam sweeping from the time point 1102 after N slots from the slot 1101 in which the RC receives the control signal to repeatedly transmit the L SSB signals according to an SSB period 1104 during the time interval 1105 in which the specific reflection pattern is applied. According to an embodiment, N may be set considering processing time of the RC. For example, N may be set to a value greater than the processing time of the RC.

Referring to (b) in FIG. 11, information about timing at which measurement is started to obtain an optimal beam of a base station and an optimal reflection pattern of an RIS included in a control signal may include an offset value indicating a period at which synchronization signals for each of a plurality of beams of the base station are transmitted. According to an embodiment, a time interval 1105 in which a specific reflection pattern among a plurality of reflection patterns of the RIS is applied may start from a time point 1103 after a synchronization signal period 1104 which corresponds to information about timing included in the control signal from a slot 1101 in which an RC receives a control signal, and synchronization signals corresponding to each of a plurality of beams of the base station may be repeatedly transmitted according to a specific period during the time interval 1105 in which the specific reflection pattern is applied. For example, the synchronization signal may be a synchronization signal block (SSB) signal, and the base station may map each of L beams to L SSB signals for beam sweeping from the time point 1103 after the synchronization signal period 1104 from the slot 1101 in which the RC receives the control signal to repeatedly transmit the L SSB signals according to an SSB period 1104 during the time interval 1105 in which the specific reflection pattern is applied.

In FIG. 11, embodiments in which an offset value from a time point at which an RC receives a control signal and a time point at which measurement starts to obtain an optimal beam of a base station and an optimal reflection pattern of an RIS is a slot unit have been described, however, a scheme similar to that in FIG. 11 may be also applied to a case that the offset value from the time point at which the RC receives the control signal and the time point at which the measurement starts to obtain the optimal beam of the base station and the optimal reflection pattern of the RIS is a symbol unit. In addition, in FIG. 11, a case that an RC is a general terminal which is connected to a base station through in-band has been described, however, FIG. 11 is also applicable to a case that the RC may receive a synchronization signal of the base station to identify a frame structure of the base station.

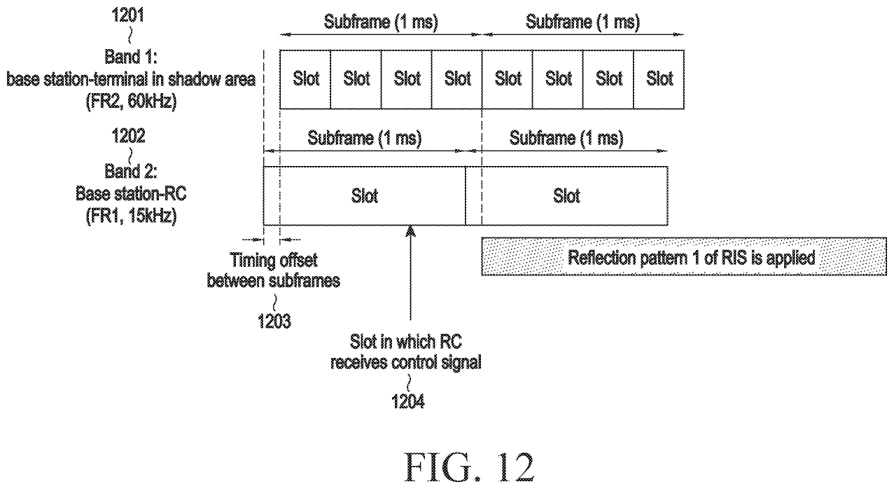

FIG. 12 is a diagram for explaining information about timing at which measurement is started to obtain an optimal beam of a base station and an optimal reflection pattern of an RIS in a case that the base station and an RC are connected through out-band according to the first embodiment of the disclosure.

Referring to FIG. 12, a base station and a test terminal located at a target shadow area may perform a communication via the first band 1201, and the base station and an RC may perform a communication via the second band 1202. For example, the first band 1201 may correspond to a frequency range 2 (FR2) and include a frequency band (e.g., mmWave) of 24 GHz to 100 GHz, and the second band 1202 may correspond to a frequency range 1 (FR1) and include a frequency band lower than or equal to 6 GHz.

According to an embodiment, information about timing at which measurement is started to obtain an optimal beam of the base station and an optimal reflection pattern of an RIS included in a control signal may include at least one of a numerology of the first band 1201, information about a timing offset 1203 between subframes of the first band 1201 and the second band 1202, and information about an offset at which the measurement is started to obtain the optimal beam of the base station and the optimal reflection pattern of the RIS. At this time, the offset at which the measurement is started to obtain the optimal beam of the base station and the optimal reflection pattern of the RIS may be set in a symbol, slot, or subframe unit. For example, the offset at which the measurement is started to obtain the optimal beam of the base station and the optimal reflection pattern of the RIS may have N symbol values, N slot values, or N subframe values. According to an embodiment, N may be set considering processing time of the RC. For example, N may be set to a value greater than the processing time of the RC.

According to an embodiment, the time point at which the measurement is stared to obtain the optimal beam of the base station and the optimal reflection pattern of the RIS included in the timing information may correspond to a time point after N slots which correspond to the offset at which the measurement is started to obtain the optimal beam of the base station and the optimal reflection pattern of the RIS from the slot 1204 in which the RC receives the control signal in the second band 1202, based on a slot of the first band 1201.

According to another embodiment, the time point at which the measurement is stared to obtain the optimal beam of the base station and the optimal reflection pattern of the RIS included in the timing information may correspond to a time point after N slots which correspond to the offset at which the measurement is started to obtain the optimal beam of the base station and the optimal reflection pattern of the RIS from the slot 1204 in which the RC receives the control signal in the second band 1202, based on a slot of the second band 1202.

According to still another embodiment, the time point at which the measurement is stared to obtain the optimal beam of the base station and the optimal reflection pattern of the RIS included in the timing information may correspond to a time point after N subframes which correspond to the offset at which the measurement is started to obtain the optimal beam of the base station and the optimal reflection pattern of the RIS from a subframe in which the control signal is received, based on a subframe.

According to still another embodiment, the time point at which the measurement is stared to obtain the optimal beam of the base station and the optimal reflection pattern of the RIS included in the timing information may correspond to a time point after N symbols which correspond to the offset at which the measurement is started to obtain the optimal beam of the base station and the optimal reflection pattern of the RIS from a symbol in which the control signal is received, based on a symbol of the first band 1201 or the second band 1202.

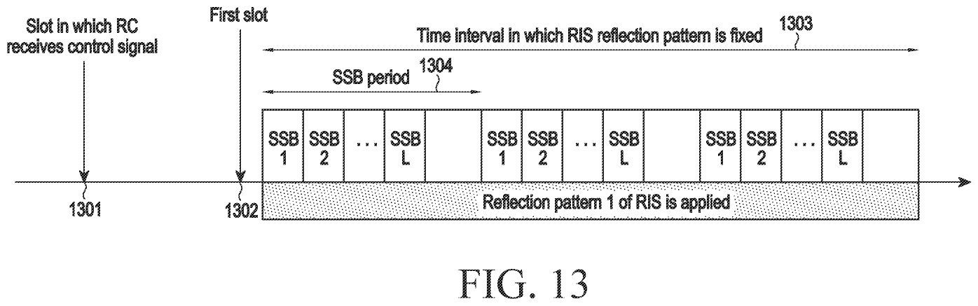

FIG. 13 is a diagram for explaining information about timing at which measurement needs to be started to obtain an optimal beam of a base station and an optimal reflection pattern of an RIS in a case that the base station and an RC are connected via other communication scheme according to the first embodiment of the disclosure.

Referring to FIG. 13, information about timing at which measurement needs to be started to obtain an optimal beam of a base station and an optimal reflection pattern of an RIS included in a control signal may include information indicating start of the measurement for obtaining the optimal beam of the base station and the optimal reflection pattern of the RIS immediately after reception of the control signal, or information about an offset set in a unit of absolute time (e.g., s, ms, μs) based on reception time of the control signal. For example, the synchronization signal may be a synchronization signal block (SSB) signal, and the base station may map each of L beams to L SSB signals for beam sweeping from the time point 1302 which corresponds to a slot immediately next to the slot 1301 in which the RC receives the control signal to repeatedly transmit the L SSB signals according to an SSB period 1304 during the time interval 1303 in which the specific reflection pattern is applied.

### Second Embodiment

The second embodiment of the disclosure relates to an embodiment of obtaining an optimal beam of a base station and an optimal reflection pattern of an RIS in a target shadow area via a random access procedure of a test terminal located within the target shadow area.

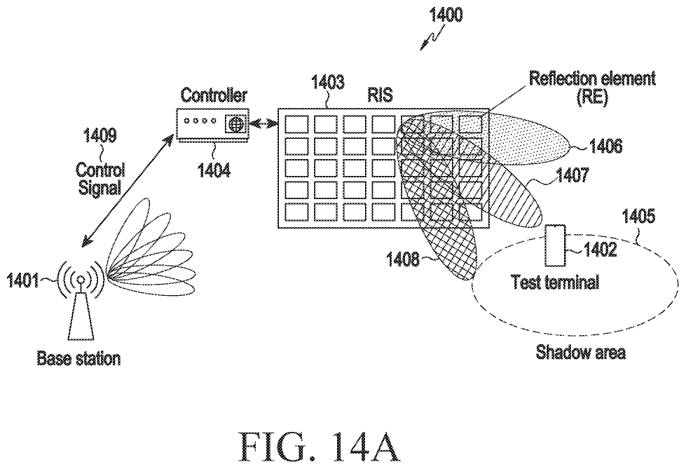

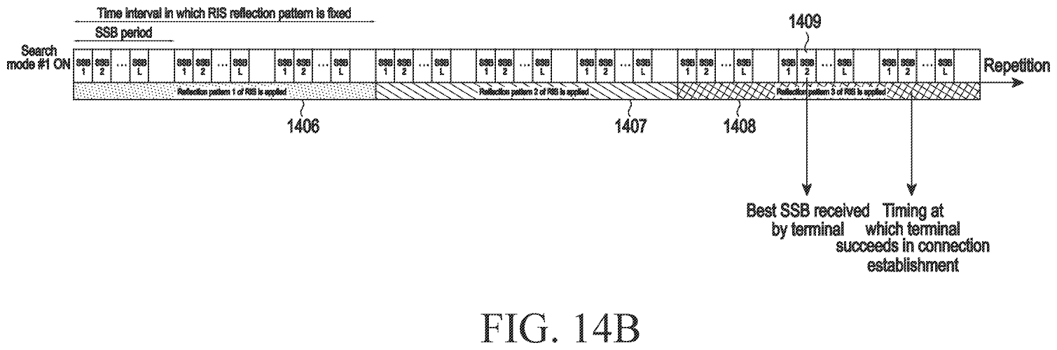

FIGS. 14A and 14B are diagrams for explaining a method for a test terminal to obtain an optimal beam of a base station and an optimal reflection pattern of an RIS by performing a random access procedure with the base station according to the second embodiment of the disclosure. FIG. 14A is a diagram illustrating a wireless communication system according to the second embodiment, and FIG. 14B is a diagram for explaining an operation of a base station and a test terminal according to the second embodiment of the disclosure.

Referring to FIGS. 14A and 14B, in a wireless communication system 1400, a test terminal 1402 located at a target shadow area 1405 may perform a random access procedure with a base station 1401. According to an embodiment, when transmitting synchronization signals for each of a plurality of beams (e.g., L beams) to the test terminal 1402 in the target shadow area 1405 to obtain an optimal beam of the base station 1401 and an optimal reflection pattern of an RIS 1403 for the target shadow area 1405, the base station 1401 may transmit a control signal 1409 to the RC 1404 such that the RIS 1403 applies a specific reflection pattern, for example, one of the first reflection pattern 1406, the second reflection pattern 1407, and the third reflection pattern 1408, during a time interval consisting of a single or a plurality of synchronization signal periods. In this case, a time interval in which the specific reflection pattern is applied may be set to time long enough for the test terminal 1402 to succeed in the random access procedure to establish a connection with the base station 1401. The control signal will be described in detail with reference to FIG. 10.

According to an embodiment, if the test terminal 1402 succeeds in the random access procedure and succeeds in establishing the connection with the base station 1401, in the time interval to which the specific reflection pattern is applied, the base station 1401 may determine the specific reflection pattern applied to the time interval as the optimal reflection pattern of the RIS 1403 for the target shadow area 1405, obtain indication information (e.g., index information for a synchronization signal) for a specific synchronization signal via the random access procedure, and determine a beam of the base station corresponding to the indication information for the specific synchronization signal as the optimal beam of the base station 1401 for the target shadow area 1405. For example, if the test terminal 1402 succeeds in the random access procedure and succeeds in establishing a connection with the base station 1401, in the time interval to which the third reflection pattern 1408 is applied, the base station 1401 may determine the third reflection pattern 1408 as the optimal reflection pattern of the RIS 1403 for the target shadow area 1405, obtain index information for an SSB 2 signal 1409 among L SSB signals corresponding to L beams of the base station 1401 via the random access procedure, and determine a beam of the base station corresponding to the index information for the SSB 2 signal 1409 as the optimal beam of the base station 1401 for the target shadow area 1405.

According to an embodiment, if the test terminal 1402 fails to establish the connection with the base station 1401 in the time interval to which the specific reflection pattern is applied, the base station 1401 may change a reflection pattern to be applied and identify whether the test terminal 1402 succeeds in establishing a connection with the base station 1401 in a time interval at which the changed reflection pattern is applied. For example, if the test terminal 1402 fails to establish a connection with the base station 1401 in a time interval at which the second reflection pattern 1407 is applied, the base station 1401 may change the second reflection pattern 1407 to the third reflection pattern 1408, and identify whether the test terminal 1402 succeeds in establishing a connection in the time interval to which the third reflection pattern 1408 is applied.

According to an embodiment, the base station 1401 may set a reflection pattern codebook of the RIS 1403 for servicing a target shadow area based on the determined optimal reflection pattern(s) of the RIS 1403. For example, the codebook may be composed of a set of optimal reflection pattern(s) of the RIS 1403 determined by the base station 1401. According to an embodiment, the base station 1401 may utilize a reflection pattern(s) of the RIS 1403 within the set codebook for a service of the target shadow area 1405 using the RIS 1403.

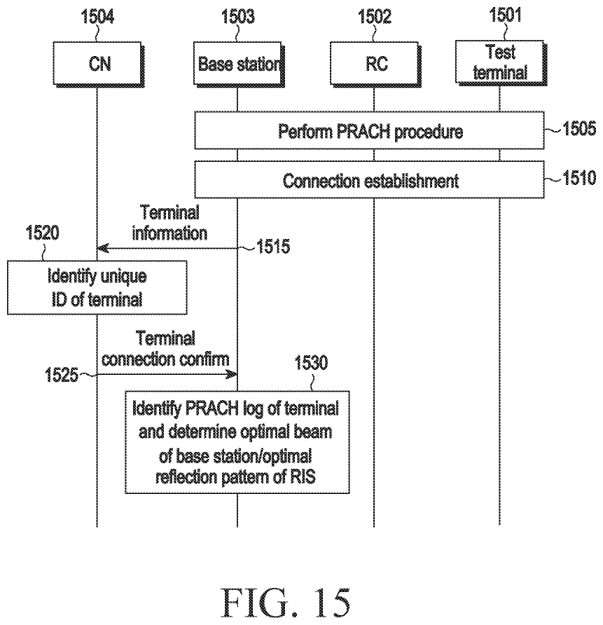

FIG. 15 is a diagram for explaining a method for a base station to specify a test terminal according to the second embodiment of the disclosure.

Referring to FIG. 15, in step 1505, a test terminal 1501 may perform a random access procedure with a base station 1503. The test terminal 1501, which succeeds in the random access procedure in step 1505, may perform connection establishment with the base station 1503 in step 1510. In step 1515, the base station 1503 may transfer terminal information about the test terminal 1501 which the base station 1503 knows in advance to a core network (CN) 1504 (e.g., an access and management function (AMF)). At this time, the terminal information may include unique ID (identifier) information (e.g., a globally unique temporary identifier (GUTI), an international mobile subscriber identity (IMSI), etc.) of the test terminal 1502. In step 1520, the CN 1504 may use the terminal information about the test terminal 1502 received from the base station 1503 in step 1515 to identify whether the test terminal 1501 has completed the connection establishment with the base station 1503. In step 1525, the CN 1504 may transfer information indicating that the test terminal 1501 has completed the connection establishment with the base station 1503 to the base station 1503. In step 1530, the base station 1503 may identify that the test terminal 1501 has completed the connection establishment with the base station 1503, and may identify log information of the test terminal 1501 during the random access procedure to determine an optimal beam of the base station 1501 and an optimal reflection pattern of an RIS (not shown) for a target shadow area at which the test terminal 1501 is located, based on the log information.

### Third Embodiment

The third embodiment of the disclosure relates to an embodiment of obtaining an optimal beam of a base station and an optimal reflection pattern of an RIS in a target shadow area via a random access procedure of one or more general terminals located within or outside the target shadow area.

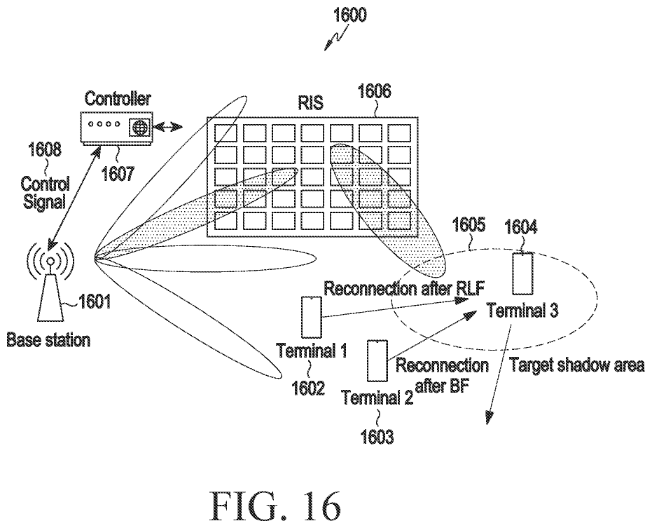

FIG. 16 is a diagram for explaining a method for a general terminal to obtain an optimal beam of a base station and an optimal reflection pattern of an RIS by performing a random access procedure with the base station according to the third embodiment of the disclosure.

Referring to FIG. 16, a base station 1601 may identify a location of a target shadow area 1605 to obtain location information about general terminals 1602, 1603, and 1604 near the target shadow area 1605, and store an identifier (e.g., a cell-radio network temporary identifier (C-RNTI)) for the general terminals 1602, 1603, and 1604 based on the location information. At this time, among the general terminals 1602, 1603, and 1604 near the shadow area, the first terminal 1602 may correspond to a terminal whose location information gradually is directed to the target shadow area 1605, the second terminal 1603 may correspond to a terminal whose location information is immediately adjacent to the target shadow area 1605, and the third terminal 1603 may correspond to a terminal whose location information is located within the target shadow area 1605.

According to an embodiment, the terminals 1602, 1603, and 1604 may be connected to the base station 1601 again with the same identifier (e.g., a C-RNTI) after suffering radio link failure (RLF) and/or beam failure (BF). According to an embodiment, if the general terminals 1602, 1603, and 1604 suffer the RLF and/or the BF, the base station 1601 may transmit a control signal 1608 to an RC 1607 such that an RIS 1696 applies one of specific reflection patterns during a time interval consisting of a single or a plurality of synchronization signal periods, when transmitting synchronization signals for each of a plurality of beams (e.g., L beams) to the general terminals 1602, 1603, and 1604 in the target shadow area 1605 to obtain the optimal beam(s) of the base station 1601 and the optimal reflection pattern(s) of the RIS 1606 for the target shadow area 1605. At this time, the time interval to which the specific reflection pattern is applied may be set to time long enough for the general terminals 1602, 1603, and 1604 to succeed in a random access procedure to establish a connection with the base station 1601 again. According to an embodiment, the base station 1601 identifies whether the general terminals 1602, 1603, and 1604 which suffer the RLF and/or the BF are connected to the base station 1601 again with the same identifier. According to an embodiment, if the general terminals 1602, 1603, and 1604 which suffer the RLF and/or the BF are connected to the base station 1601 again with the same identifier, the base station 1601 may identify log of the random access procedure performed in a process in which the general terminals 1602, 1603, and 1604 are connected again and identify indication information of a synchronization signal for which the random access procedure is successful to determine the optimal beam of the base station 1601 and the optimal reflection pattern of the RIS 1606 in the target shadow area 1605.

According to an embodiment, determining whether the general terminals 1602, 1603, and 1604 establish a connection with the BS 160 again after suffering the RLF and/or the BF may be complexly performed in consideration of all of the general terminals 1602, 1603, and 1604. According to an embodiment, as the number of general terminals located near the target shadow area 1605 increases, accuracy of the optimal beam of the base station 1601 and the optimal reflection pattern of the RIS 1606 for the target shadow area 1605 will be improved.

According to an embodiment, the base station 1601 may set a reflection pattern codebook of the RIS 1606 for servicing a target shadow area, based on the determined optimal reflection pattern(s) of the RIS 1606. For example, the codebook may be composed of a set of optimal reflection pattern(s) of the RIS 1606 determined by the base station 1601. According to an embodiment, the base station 1601 may utilize the reflection pattern(s) of the RIS 1606 within the set codebook for a service of the target shadow area 1605 using the RIS 1606.

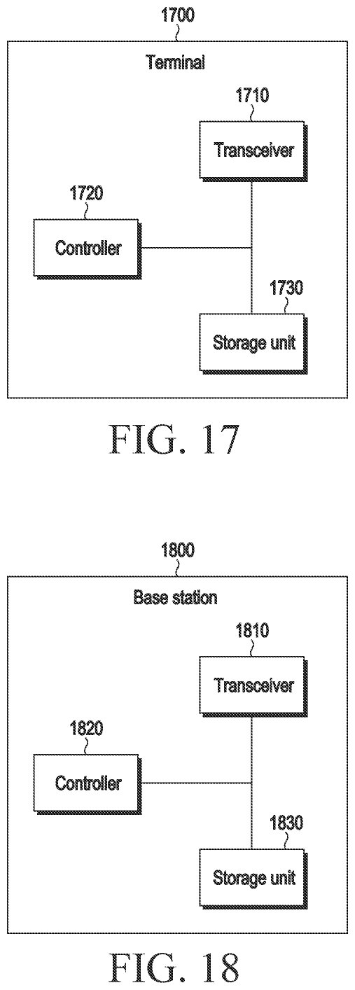

FIG. 17 is a diagram schematically illustrating an internal structure of a terminal according to an embodiment of the disclosure.

Referring to FIG. 17, a terminal 1700 may include a transceiver 1710, a controller 1720, and a storage unit 1730. The controller 1710 may be defined as a circuit or an application-specific integrated circuit or at least one processor.

The transceiver 1710 may transmit and receive a signal to and from another network entity. For example, the transceiver 1710 may receive a synchronization signal of a base station via beam(s) reflected from an RIS, or may transmit a measurement report for the synchronization signal to the base station.

The controller 1720 may control the overall operation of the terminal 1700 according to embodiments proposed in the disclosure. For example, the controller 1720 may control a signal flow between respective blocks to perform an operation according to a procedure described above with reference to FIGS. 6 to 16. For example, the controller 1720 may control an operation proposed in the disclosure, such as measuring a plurality of synchronization signals received from the base station according to the above-described embodiments.

The storage unit 1730 may store at least one of information transmitted and received via the transceiver 1710 and information generated via the controller 1720. For example, the storage unit 1730 may store information about timing according to the above-described embodiment and/or the like.

FIG. 18 is a diagram schematically illustrating an internal structure of a base station according to an embodiment of the disclosure.

Referring to FIG. 18, a base station 1800 may include a transceiver 1810, a controller 1820, and a storage unit 1830. The controller 1810 may be defined as a circuit or an application-specific integrated circuit or at least one processor.

The transceiver 1810 may transmit and receive a signal to and from another network entity. For example, the transceiver 1810 may transmit a control signal to an RC or may transmit a synchronization signal to a terminal.

The controller 1820 may control the overall operation of the base station 1800 according to embodiments proposed in the disclosure. For example, the controller 1820 may control a signal flow between respective blocks to perform an operation according to a procedure described above with reference to FIGS. 6 to 16. For example, the controller 1820 may control an operation proposed in the disclosure, such as determining an optimal beam of the base station 1700 and an optimal reflection pattern of an RIS for a target shadow area according to the above-described embodiments.

The storage unit 1830 may store at least one of information transmitted and received via the transceiver 1810 and information generated via the controller 1820. For example, the storage unit 1830 may store information about timing according to the above-described embodiment and/or the like.

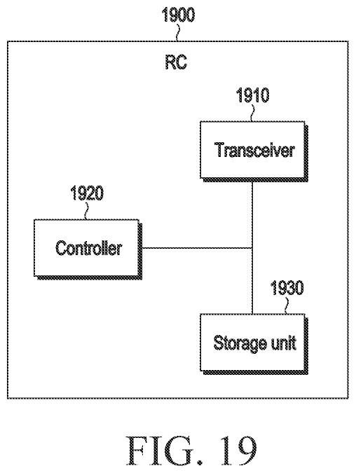

FIG. 19 is a diagram schematically illustrating an internal structure of an RC according to an embodiment of the disclosure.

Referring to FIG. 19, an RC 1900 may include a transceiver 1910, a controller 1920, and a storage unit 1930. The controller 1910 may be defined as a circuit or an application-specific integrated circuit or at least one processor.

The transceiver 1910 may transmit and receive a signal to and from another network entity. For example, the transceiver 1910 may receive a control signal from a base station.

The controller 1920 may control the overall operation of the RC 1900 according to embodiments proposed in the disclosure. For example, the controller 1920 may control a signal flow between respective blocks to perform an operation according to a procedure described above with reference to FIGS. 6 to 16. For example, the controller 1920 may control an operation proposed in the disclosure, such as controlling an RIS based on a control signal according to the above-described embodiments.

The storage unit 1930 may store at least one of information transmitted and received via the transceiver 1910 and information generated via the controller 1920. For example, the storage unit 1930 may store a control signal, etc. according to the above-described embodiment.

Embodiments disclosed in the specification and drawings above merely provide a specific example to easily explain technical content of the disclosure and aid understanding, and are not intended to limit a scope of the disclosure. Further, one or more of various embodiments described above may be combined and performed. Accordingly, the scope of the disclosure should be construed as including all changes or modified forms derived based on the disclosure in addition to embodiments disclosed herein.

1. A method of a base station supporting beamforming in a wireless communication system, the method comprising:
transmitting control information for controlling a plurality of reflection patterns of a reconfiguration intelligent surface (RIS) to an RIS controller (RC);
transmitting synchronization signals corresponding to a plurality of beams of the base station for each of the plurality of reflection patterns controlled based on the control information to a terminal located in a shadow area via the RIS;
receiving a measurement report including a measurement result of measuring strength of the synchronization signals corresponding to the plurality of beams of the base station for each of the plurality of reflection patterns from the terminal;
selecting at least one beam among the plurality of beams and at least one reflection pattern among the plurality of reflection patterns as an optimal beam and an optimal reflection pattern for the shadow area, based on the measurement result included in the measurement report; and
generating a codebook for the RIS based on the selected optimal reflection pattern for the shadow area.

2. The method of claim 1, wherein the control information is transmitted once for the plurality of reflection patterns.

3. The method of claim 2, wherein the control information includes at least one of timing information indicating a time point at which the terminal measures the strength of the synchronization signals corresponding to the plurality of beams of the base station for each of the plurality of reflection patterns, indication information indicating each of the plurality of reflection patterns and order information indicating an order in which the plurality of reflection patterns are controlled, information about a transmission period of the synchronization signals corresponding to the plurality of beams, and information indicating a number of times the transmission period of the synchronization signals is repeated for each of the plurality of reflection patterns.

4. The method of claim 2, wherein the control information includes at least one of timing information indicating a time point at which the terminal measures the strength of the synchronization signals corresponding to the plurality of beams of the base station for each of the plurality of reflection patterns, indication information indicating each of the plurality of reflection patterns and information indicating an order in which the plurality of reflection patterns are controlled, and information indicating time at which each of the plurality of reflection patterns is controlled.

5. The method of claim 1, wherein the control information is transmitted for each of the plurality of reflection patterns.

6. The method of claim 5, wherein the control information includes at least one of timing information indicating a time point at which the terminal measures the strength of the synchronization signals corresponding to the plurality of beams of the base station for a reflection pattern corresponding to the control information, indication information indicating the reflection pattern corresponding to the control information among the plurality of reflection patterns, information about a transmission period of the synchronization signals corresponding to the plurality of beams, and information indicating a number of times the transmission period of the synchronization signals is repeated for the reflection pattern corresponding to the control information.

7. The method of claim 5, wherein the control information includes at least one of timing information indicating a time point at which the terminal measures the strength of the synchronization signals corresponding to the plurality of beams of the base station for a reflection pattern corresponding to the control information, indication information indicating the reflection pattern corresponding to the control information among the plurality of reflection patterns, and information indicating a time at which the reflection pattern corresponding to the control information is controlled.

8. The method of claim 1, wherein the measurement result includes, for each of the plurality of reflection patterns, information about at least one reflection pattern and at least one beam, which correspond to a case that strength of a signal among the synchronization signals corresponding to the plurality of beams satisfies a predetermined threshold value or more.

9. A base station supporting beamforming in a wireless communication system, the base station comprising:
a transceiver; and
a controller configured to:
control the transceiver to transmit control information for controlling a plurality of reflection patterns of a reconfiguration intelligent surface (RIS) to an RIS controller (RC),
control the transceiver to transmit synchronization signals corresponding to a plurality of beams of the base station for each of the plurality of reflection patterns controlled based on the control information to a terminal located in a shadow area via the RIS,
control the transceiver to receive a measurement report including a measurement result of measuring strength of the synchronization signals corresponding to the plurality of beams of the base station for each of the plurality of reflection patterns from the terminal,
select at least one beam among the plurality of beams and at least one reflection pattern among the plurality of reflection patterns as an optimal beam and an optimal reflection pattern for the shadow area, based on the measurement result included in the measurement report, and
generate a codebook for the RIS based on the selected optimal reflection pattern for the shadow area.

10. The base station of claim 9, wherein the control information is transmitted once for the plurality of reflection patterns.

11. (canceled)

12. A base station supporting beamforming in a wireless communication system, the base station comprising:
a transceiver; and
a controller configured to:
control the transceiver to transmit control information for controlling at least one reflection pattern among a plurality of reflection patterns of a reconfiguration intelligent surface (RIS) during a predetermined time interval to an RIS controller (RC),
control the transceiver to transmit synchronization signals corresponding to a plurality of beams of the base station for the at least one reflection pattern controlled based on the control information during the predetermined time interval to a terminal located at a shadow area via the RIS,
identify whether the terminal establishes a connection with the base station according to a random access procedure during the predetermined time interval,
if the terminal establishes the connection with the base station according to the random access procedure during the predetermined time interval, identify log information associated with the random access procedure of the terminal,
identify at least one synchronization signal for which the random access procedure is successfully performed among the plurality of synchronization signals from the log information,
select the at least one reflection pattern and a beam corresponding to the at least one synchronization signal among the plurality of beams as an optimal reflection pattern and an optimal beam for the shadow area, respectively, and
generate a codebook for the RIS based on the selected optimal reflection pattern for the shadow area.

13.-14. (canceled)

15. The base station of claim 10, wherein the control information includes at least one of timing information indicating a time point at which the terminal measures the strength of the synchronization signals corresponding to the plurality of beams of the base station for each of the plurality of reflection patterns, indication information indicating each of the plurality of reflection patterns and order information indicating an order in which the plurality of reflection patterns are controlled, information about a transmission period of the synchronization signals corresponding to the plurality of beams, and information indicating a number of times the transmission period of the synchronization signals is repeated for each of the plurality of reflection patterns.

16. The base station of claim 10, wherein the control information includes at least one of timing information indicating a time point at which the terminal measures the strength of the synchronization signals corresponding to the plurality of beams of the base station for each of the plurality of reflection patterns, indication information indicating each of the plurality of reflection patterns and information indicating an order in which the plurality of reflection patterns are controlled, and information indicating time at which each of the plurality of reflection patterns is controlled.

17. The base station of claim 9, wherein the control information is transmitted for each of the plurality of reflection patterns.

18. The base station of claim 17, wherein the control information includes at least one of timing information indicating a time point at which the terminal measures the strength of the synchronization signals corresponding to the plurality of beams of the base station for a reflection pattern corresponding to the control information, indication information indicating the reflection pattern corresponding to the control information among the plurality of reflection patterns, information about a transmission period of the synchronization signals corresponding to the plurality of beams, and information indicating a number of times the transmission period of the synchronization signals is repeated for the reflection pattern corresponding to the control information.

19. The base station of claim 17, wherein the control information includes at least one of timing information indicating a time point at which the terminal measures the strength of the synchronization signals corresponding to the plurality of beams of the base station for a reflection pattern corresponding to the control information, indication information indicating the reflection pattern corresponding to the control information among the plurality of reflection patterns, and information indicating a time at which the reflection pattern corresponding to the control information is controlled.

20. The base station of claim 9, wherein the measurement result includes, for each of the plurality of reflection patterns, information about at least one reflection pattern and at least one beam, which correspond to a case that strength of a signal among the synchronization signals corresponding to the plurality of beams satisfies a predetermined threshold value or more.

21. The base station of claim 12, wherein the control information includes at least one of timing information indicating a time point at which the terminal measures strength of the synchronization signals corresponding to the plurality of beams of the base station for each of the plurality of reflection patterns, indication information indicating each of the plurality of reflection patterns and order information indicating an order in which the plurality of reflection patterns are controlled, information about a transmission period of the synchronization signals corresponding to the plurality of beams, and information indicating a number of times the transmission period of the synchronization signals is repeated for each of the plurality of reflection patterns.

22. The base station of claim 12, wherein the control information includes at least one of timing information indicating a time point at which the terminal measures strength of the synchronization signals corresponding to the plurality of beams of the base station for a reflection pattern corresponding to the control information, indication information indicating the reflection pattern corresponding to the control information among the plurality of reflection patterns, information about a transmission period of the synchronization signals corresponding to the plurality of beams, and information indicating a number of times the transmission period of the synchronization signals is repeated for the reflection pattern corresponding to the control information.

23. The base station of claim 12,
wherein the control information includes at least one of timing information indicating a time point at which the terminal measures strength of the synchronization signals corresponding to the plurality of beams of the base station for each of the plurality of reflection patterns, indication information indicating each of the plurality of reflection patterns and information indicating an order in which the plurality of reflection patterns are controlled, and information indicating time at which each of the plurality of reflection patterns is controlled, or
wherein the control information includes at least one of timing information indicating a time point at which the terminal measures the strength of the synchronization signals corresponding to the plurality of beams of the base station for a reflection pattern corresponding to the control information, indication information indicating the reflection pattern corresponding to the control information among the plurality of reflection patterns, and information indicating a time at which the reflection pattern corresponding to the control information is controlled.
